(19) United States
(12) Patent Application Publication
(10) Pub. No.: US 2026/0227865 A1
(43) Pub. Date: Aug. 6, 2026

(54) WEARABLE DEVICE, METHOD, AND NON-TRANSITORY COMPUTER READABLE STORAGE MEDIUM FOR GESTURE INPUT

(71) Applicant: SAMSUNG ELECTRONICS CO., LTD., Suwon-si (KR)

(72) Inventors: Hyunsoo KIM, Suwon-si (KR); Geonsoo KIM, Suwon-si (KR); Jeongmin PARK, Suwon-si (KR); Dongil SON, Suwon-si (KR); Bokun CHOI, Suwon-si (KR); Minkyung HWANG, Suwon-si (KR)

(73) Assignee: SAMSUNG ELECTRONICS CO., LTD., Suwon-si (KR)

(21) Appl. No.: 19/578,058

(22) Filed: Mar. 25, 2026

Related U.S. Application Data
(63) Continuation of application No. PCT/KR2024/011153, filed on Jul. 30, 2024.

(30) Foreign Application Priority Data
Sep. 27, 2023 (KR) 10-2023-0131262
Oct. 13, 2023 (KR) 10-2023-0137177

(51) Int. Cl. G06F 3/01; G02B 27/01; G06F 1/3231; G06F 3/033; G06V 40/10; G06V 40/20; H02J 7/82

(52) U.S. Cl. CPC G06F 3/017; G02B 27/0101; G02B 27/017; G06F 1/3231; G06F 3/033; G06V 40/10; G06V 40/28; H02J 7/82; G02B 2027/0138; G06F 2203/0331

(57) ABSTRACT

A method of a wearable device including a camera configured to capture an image of a part of a body of a user, includes: identifying a relative movement of a hand of the user wearing another wearable device in a FOV, wherein the other wearable device is in a low-power state; setting a first area within a first distance corresponding to the relative movement from an obstruction area in which the hand is not identified through the FOV of the camera; based on identifying that the hand moves into the first area, requesting the motion data from the other wearable device; obtain motion data from the other wearable device transitioning from the low-power state to a normal state based on the hand moving into the first area; and identifying, based on the motion data, a gesture of the user through the hand.

### CROSS-REFERENCE TO RELATED APPLICATIONS

This application is a by-pass continuation application of International Application No. PCT/KR2024/011153, filed on July 30, 2024, which is based on and claims priority to Korean Patent Application No. 10-2023-0131262, filed on September 27, 2023, and Korean Patent Application No. 10-2023-0137177, filed on October 13, 2023, in the Ministry of Intellectual Property, the disclosures of which are incorporated by reference herein their entireties.

### BACKGROUND

### 1. Field

The present disclosure relates to a wearable device, a method, and a non-transitory computer readable storage medium for a gesture input.

### 2. Description of Related Art

In order to provide enhanced user experience, an electronic device that provides an augmented reality (AR) service that displays information generated by a computer in connection with an external object in the real-world is being developed. The electronic device may be a wearable device that may be worn by a user. For example, the electronic device may be AR glasses and/or a head-mounted device (HMD). The electronic device may identify a gesture of the user through a camera.

### SUMMARY

According to an aspect of the present disclosure, a wearable device including: communication circuitry; a camera configured to capture an image of a part of a body of a user wearing the wearable device; at least one processor including processing circuitry; and memory including one or more storage mediums storing instructions, wherein the instructions, when executed by the at least one processor individually or collectively, cause the wearable device to: identify a relative movement of a hand of the user wearing another wearable device in a field-of-view (FOV) of the camera, wherein the other wearable device is in a low-power state in which obtaining motion data of the other wearable device, through a sensor of the other wearable device, is ceased; set a first area within a first distance corresponding to the relative movement from an obstruction area in which the hand is not identified through the FOV of the camera; based on identifying that the hand moves into the first area, request, through the communication circuitry, the motion data from the other wearable device; obtain, through the communication circuitry, motion data from the other wearable device transitioning from the low-power state to a normal state based on the hand moving into the first area; and identify, based on the motion data, a gesture of the user through the hand.

According to an aspect of the present disclosure, a method performed by a wearable device including communication circuitry and a camera configured to capture an image of a part of a body of a user wearing the wearable device, the method including: identifying a relative movement of a hand of the user wearing another wearable device in a field-of-view (FOV) of the camera, wherein the other wearable device is in a low-power state in which obtaining motion data of the other wearable device, through a sensor of the other wearable device, is ceased; setting a first area within a first distance corresponding to the relative movement from an obstruction area in which the hand is not identified through the FOV of the camera; based on identifying that the hand moves into the first area, requesting, through the communication circuitry, the motion data from the other wearable device; obtaining, through the communication circuitry, motion data from the other wearable device transitioning from the low-power state to a normal state based on the hand moving into the first area; and identifying, based on the motion data, a gesture of the user through the hand.

According to an aspect of the present disclosure, a non-transitory computer-readable storage medium storing a program including instructions, wherein the instructions, when executed by at least one processor of a wearable device including communication circuitry and a camera configured to capture an image of a part of a body of a user wearing the wearable device, individually or collectively, cause the wearable device to: identify a relative movement of a hand of the user wearing another wearable device in a field-of-view (FOV) of the camera, wherein the other wearable device is in a low-power state in which obtaining motion data of the other wearable device, through a sensor of the other wearable device, is ceased; set a first area within a first distance corresponding to the relative movement from an obstruction area in which the hand is not identified through the FOV of the camera; based on identifying that the hand moves into the first area, request, through the communication circuitry, the motion data from the other wearable device; obtain, through the communication circuitry, motion data from the other wearable device transitioning from the low-power state to a normal state based on the hand moving into the first area; and identify, based on the motion data, a gesture of the user through the hand.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to various embodiments;

FIG. 2A illustrates an example of a perspective view of a wearable device according to an embodiment;

FIG. 2B illustrates an example of one or more hardware disposed in a wearable device according to an embodiment;

FIG. 3A illustrates an example of an exterior of a wearable device according to an embodiment;

FIG. 3B illustrates an example of an exterior of a wearable device according to an embodiment;

FIG. 4 illustrates an example of a block diagram of a wearable device according to an embodiment;

FIG. 5A illustrates an exemplary wearable device according to an embodiment;

FIG. 5B represents a cross-section of an exemplary wearable device according to an embodiment;

FIG. 5C is a block diagram of an exemplary wearable device according to an embodiment;

FIG. 5D is a state transition diagram of an exemplary wearable device according to an embodiment;

FIG. 6A illustrates an example of a field-of-view (FOV) obtained through a camera of a wearable device worn by a user in an embodiment;

FIG. 6B illustrates an example of a situation in which a user wearing a wearable device moves a hand in an embodiment;

FIG. 6C illustrates an example of a situation in which a user wearing a wearable device moves a hand in an embodiment;

FIG. 7A illustrates an example of a distance set by a wearable device in an embodiment;

FIG. 7B illustrates an example of a distance set by a wearable device in an embodiment.

FIG. 8 illustrates an example of a situation in which a user wears a plurality of wearable devices;

FIG. 9 illustrates an example of a field-of-view (FOV) of a wearable device according to a movement of a hand of a user in an embodiment;

FIG. 10 illustrates an example of a situation of a front surface of a wearable device in an embodiment;

FIG. 11 illustrates an example of a situation in which a wearable device sets an obstruction area with respect to an obstruction object in an embodiment;

FIG. 12 is a flowchart representing an operation of a wearable device according to an embodiment;

FIG. 13 is a flowchart representing an operation of a wearable device according to an embodiment; and

FIG. 14 is a flowchart representing an operation of a wearable device according to an embodiment.

### DETAILED DESCRIPTION

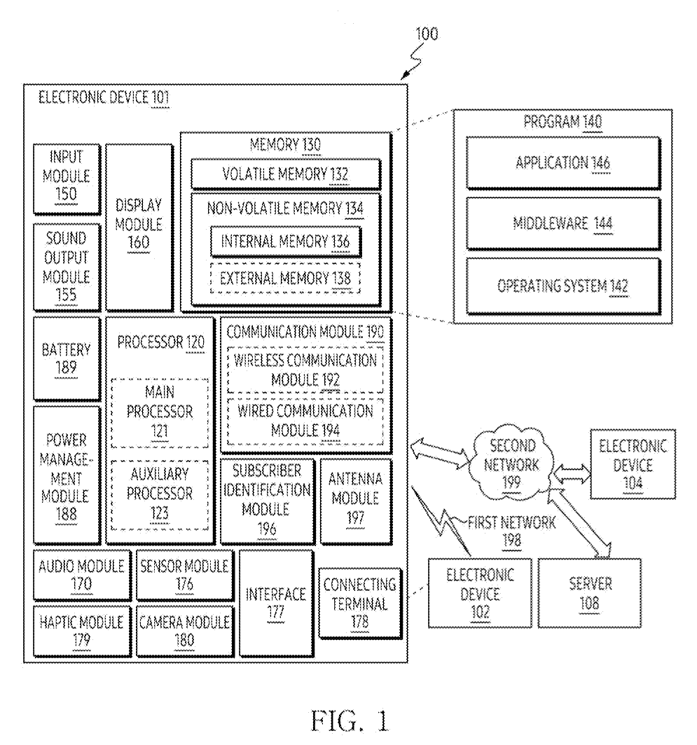

FIG. 1 is a block diagram of an electronic device in a network environment according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through at least one wire) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through at least one wire) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) between two of the above-described components via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 performs a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

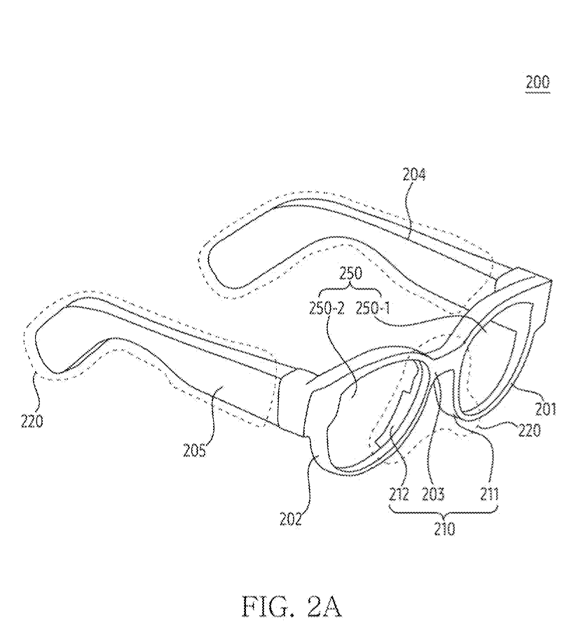

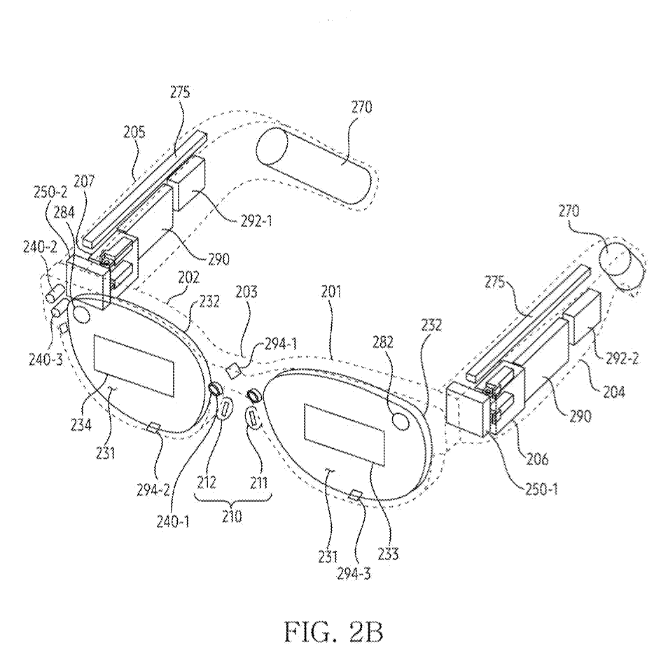

FIG. 2A illustrates an example of a perspective view of a wearable device 200 according to an embodiment. FIG. 2B illustrates an example of one or more hardware disposed in the wearable device 200 according to an embodiment.

The wearable device 200 of FIGS. 2A and 2B may correspond to the electronic device 101 of FIG. 1. As shown in FIG. 2A, the wearable device 200 according to an embodiment may include at least one display 250 and a frame supporting the at least one display 250.

According to an embodiment, the wearable device 200 may be wearable on a portion of the user’s body. The wearable device 200 may provide augmented reality (AR), virtual reality (VR), or mixed reality (MR) combining the augmented reality and the virtual reality to a user wearing the wearable device 200. For example, the wearable device 200 may output a virtual reality image through at least one display 250, in response to a user’s preset gesture obtained through a motion recognition camera 240-2 of FIG. 2B.

According to an embodiment, the at least one display 250 in the wearable device 200 may provide visual information to a user. For example, the at least one display 250 may include a transparent or translucent lens. The at least one display 250 may include a first display 250-1 and/or a second display 250-2 spaced apart from the first display 250-1. For example, the first display 250-1 and the second display 250-2 may be disposed at positions corresponding to the user’s left and right eyes, respectively.

Referring to FIG. 2B, the at least one display 250 may form a display area on the lens to provide a user wearing the wearable device 200 with visual information included in ambient light passing through the lens and other visual information distinct from the visual information. The lens may be formed based on at least one of a fresnel lens, a pancake lens, or a multi-channel lens. The display area formed by the at least one display 250 may be formed on the second surface 232 of the first surface 231 and the second surface 232 of the lens. When the user wears the wearable device 200, ambient light may be transmitted to the user by being incident on the first surface 231 and being penetrated through the second surface 232. For another example, the at least one display 250 may display a virtual reality image to be coupled with a reality screen transmitted through ambient light. The virtual reality image outputted from the at least one display 250 may be transmitted to eyes of the user, through one or more hardware (e.g., optical devices 282 and 284, and/or at least one waveguides 233 and 234) included in the wearable device 200.

According to an embodiment, the wearable device 200 may include waveguides 233 and 234 that transmit light transmitted from the at least one display 250 and relayed by the at least one optical device 282 and 284 by diffracting to the user. The waveguides 233 and 234 may be formed based on at least one of glass, plastic, or polymer. A nano pattern may be formed on at least a portion of the outside or inside of the waveguides 233 and 234. The nano pattern may be formed based on a grating structure having a polygonal or curved shape. Light incident to an end of the waveguides 233 and 234 may be propagated to another end of the waveguides 233 and 234 by the nano pattern. The waveguides 233 and 234 may include at least one of at least one diffraction element (e.g., a diffractive optical element (DOE), a holographic optical element (HOE)), and a reflection element (e.g., a reflection mirror). For example, the waveguides 233 and 234 may be disposed in the wearable device 200 to guide a screen displayed by the at least one display 250 to the user’s eyes. For example, the screen may be transmitted to the user’s eyes through total internal reflection (TIR) generated in the waveguides 233 and 234.

According to an embodiment, the wearable device 200 may analyze an object included in a real image collected through a photographing camera 240-1, combine with a virtual object corresponding to an object that become a subject of augmented reality provision among the analyzed object, and display on the at least one display 250. The virtual object may include at least one of text and images for various information associated with the object included in the real image. The wearable device 200 may analyze the object based on a multi-camera such as a stereo camera. For the object analysis, the wearable device 200 may execute time-of-flight (ToF) and/or simultaneous localization and mapping (SLAM) supported by the multi-camera. The user wearing the wearable device 200 may watch an image displayed on the at least one display 250.

According to an embodiment, a frame may be configured with a physical structure in which the wearable device 200 may be worn on the user’s body. According to an embodiment, the frame may be configured so that when the user wears the wearable device 200, the first display 250-1 and the second display 250-2 may be positioned corresponding to the user’s left and right eyes. The frame may support the at least one display 250. For example, the frame may support the first display 250-1 and the second display 250-2 to be positioned at positions corresponding to the user’s left and right eyes.

Referring to FIG. 2A, according to an embodiment, the frame may include an area 220 at least partially in contact with the portion of the user’s body in case that the user wears the wearable device 200. For example, the area 220 of the frame in contact with the portion of the user’s body may include an area in contact with a portion of the user’s nose, a portion of the user’s ear, and a portion of the side of the user’s face that the wearable device 200 contacts. According to an embodiment, the frame may include a nose pad 210 that is contacted on the portion of the user’s body. When the wearable device 200 is worn by the user, the nose pad 210 may be contacted on the portion of the user’s nose. The frame may include a first temple 204 and a second temple 205, which are contacted on another portion of the user’s body that is distinct from the portion of the user’s body.

According to an embodiment, the frame may include a first rim 201 surrounding at least a portion of the first display 250-1, a second rim 202 surrounding at least a portion of the second display 250-2, a bridge 203 disposed between the first rim 201 and the second rim 202, a first pad 211 disposed along a portion of the edge of the first rim 201 from one end of the bridge 203, a second pad 212 disposed along a portion of the edge of the second rim 202 from the other end of the bridge 203, the first temple 204 extending from the first rim 201 and fixed to a portion of the wearer’s ear, and the second temple 205 extending from the second rim 202 and fixed to a portion of the ear opposite to the ear. The first pad 211 and the second pad 212 may be in contact with the portion of the user’s nose, and the first temple 204 and the second temple 205 may be in contact with a portion of the user’s face and the portion of the user’s ear. The temples 204 and 205 may be rotatably connected to the rim through hinge units 206 and 207 of FIG. 2B. The first temple 204 may be rotatably connected with respect to the first rim 201 through the first hinge unit 206 disposed between the first rim 201 and the first temple 204. The second temple 205 may be rotatably connected with respect to the second rim 202 through the second hinge unit 207 disposed between the second rim 202 and the second temple 205. According to an embodiment, the wearable device 200 may identify an external object (e.g., a user’s fingertip) touching the frame and/or a gesture performed by the external object by using a touch sensor, a grip sensor, and/or a proximity sensor formed on at least a portion of the surface of the frame.

According to an embodiment, the wearable device 200 may include hardware (e.g., hardware described above based on the block diagram of FIG. 1) that performs various functions. For example, the hardware may include a battery module 270, an antenna module 275, optical devices 282 and 284, speakers 292-1 and 292-2, microphones 294-1, 294-2, and 294-3, a light emitting module, or a printed circuit board (PCB) 290. Various hardware may be disposed in the frame.

According to an embodiment, the microphones 294-1, 294-2, and 294-3 of the wearable device 200 may obtain a sound signal, by being disposed on at least a portion of the frame. The first microphone 294-1 disposed on the nose pad 210, the second microphone 294-2 disposed on the second rim 202, and the third microphone 294-3 disposed on the first rim 201 are illustrated in FIG. 2B, but the number and disposition of the microphone 294 are not limited to an embodiment of FIG. 2B. In a case that the number of the microphone 294 included in the wearable device 200 is two or more, the wearable device 200 may identify a direction of the sound signal by using a plurality of microphones disposed on different portions of the frame.

According to an embodiment, the optical devices 282 and 284 may transmit a virtual object transmitted from the at least one display 250 to the wave guides 233 and 234. For example, the optical devices 282 and 284 may be projectors. The optical devices 282 and 284 may be disposed adjacent to the at least one display 250 or may be included in the at least one display 250 as a portion of the at least one display 250. The first optical device 282 may correspond to the first display 250-1, and the second optical device 284 may correspond to the second display 250-2. The first optical device 282 may transmit light outputted from the first display 250-1 to the first waveguide 233, and the second optical device 284 may transmit light outputted from the second display 250-2 to the second waveguide 234.

In an embodiment, a camera 240 may include an eye tracking camera (ET CAM) 240-1, a motion recognition camera 240-2 and/or the photographing camera 240-3. The photographing camera, the eye tracking camera 240-1, and the motion recognition camera 240-2 may be disposed at different positions on the frame and may perform different functions. The eye tracking camera 240-1 may output data indicating a gaze of the user wearing the wearable device 200. For example, the wearable device 200 may detect the gaze from an image including the user’s pupil, obtained through the eye tracking camera 240-1. An example in which the eye tracking camera 240-1 is disposed toward the user’s right eye is illustrated in FIG. 2B, but the embodiment is not limited thereto, and the eye tracking camera 240-1 may be disposed alone toward the user’s left eye or may be disposed toward two eyes.

In an embodiment, the photographing camera 240-3 may photograph a real image or background to be matched with a virtual image in order to implement the augmented reality or mixed reality content. The photographing camera may photograph an image of a specific object existing at a position viewed by the user and may provide the image to the at least one display 250. The at least one display 250 may display one image in which a virtual image provided through the optical devices 282 and 284 is overlapped with information on the real image or background including the image of the specific object obtained by using the photographing camera. In an embodiment, the photographing camera may be disposed on the bridge 203 disposed between the first rim 201 and the second rim 202.

In an embodiment, the eye tracking camera 240-1 may implement a more realistic augmented reality by matching the user’s gaze with the visual information provided on the at least one display 250, by tracking the gaze of the user wearing the wearable device 200. For example, when the user looks at the front, the wearable device 200 may naturally display environment information associated with the user’s front on the at least one display 250 at a position where the user is positioned. The eye tracking camera 240-1 may be configured to capture an image of the user’s pupil in order to determine the user’s gaze. For example, the eye tracking camera 240-1 may receive gaze detection light reflected from the user’s pupil and may track the user’s gaze based on the position and movement of the received gaze detection light. In an embodiment, the eye tracking camera 240-1 may be disposed at a position corresponding to the user’s left and right eyes. For example, the eye tracking camera 240-1 may be disposed in the first rim 201 and/or the second rim 202 to face the direction in which the user wearing the wearable device 200 is positioned.

The motion recognition camera 240-2 may provide a specific event to the screen provided on the at least one display 250 by recognizing the movement of the whole or portion of the user’s body, such as the user’s torso, hand, or face. The motion recognition camera 240-2 may obtain a signal corresponding to motion by recognizing the user’s gesture, and may provide a display corresponding to the signal to the at least one display 250. A processor may identify a signal corresponding to the operation and may perform a preset function based on the identification. In an embodiment, the motion recognition camera 240-2 may be disposed on the first rim 201 and/or the second rim 202.

In an embodiment, the camera 240 included in the wearable device 200 is not limited to the above-described eye tracking camera 240-1 and the motion recognition camera 240-2. For example, the wearable device 200 may identify an external object included in the FoV by using the photographing camera 240-3 disposed toward the user’s FoV. Identifying of the external object by the wearable device 200 may be performed through a sensor for identifying a distance between the wearable device 200 and the external object, such as a depth sensor and/or a time of flight (ToF) sensor. The camera 240 disposed toward the FoV may support an autofocus function and/or an optical image stabilization (OIS) function. For example, the wearable device 200 may include a camera 240 (e.g., a face tracking (FT) camera) disposed toward a face of a user wearing the wearable device 200 to obtain an image including the user’s face.

The wearable device 200 according to an embodiment may further include a light source (e.g., LED) that emits light toward a subject (e.g., user’s eyes, face, and/or an external object in the FoV) photographed by using the camera 240. The light source may include an LED having an infrared wavelength. The light source may be disposed on at least one of the frame, and the hinge units 206 and 207.

According to an embodiment, the battery module 270 may supply power to electronic components of the wearable device 200. In an embodiment, the battery module 270 may be disposed in the first temple 204 and/or the second temple 205. For example, the battery module 270 may be a plurality of battery modules 270. The plurality of battery modules 270, respectively, may be disposed on each of the first temple 204 and the second temple 205. In an embodiment, the battery module 270 may be disposed at an end of the first temple 204 and/or the second temple 205.

According to an embodiment, the antenna module 275 may transmit the signal or power to the outside of the wearable device 200 or may receive the signal or power from the outside. The antenna module 275 may be electrically and/or operably connected to the communication module 190 of FIG. 1. In an embodiment, the antenna module 275 may be disposed in the first temple 204 and/or the second temple 205. For example, the antenna module 275 may be disposed close to one surface of the first temple 204 and/or the second temple 205.

According to an embodiment, the speakers 292-1 and 292-2 may output a sound signal to the outside of the wearable device 200. A sound output module may be referred to as a speaker. In an embodiment, the speakers 292-1 and 292-2 may be disposed in the first temple 204 and/or the second temple 205 in order to be disposed adjacent to the ear of the user wearing the wearable device 200. For example, the wearable device 200 may include a second speaker 292-2 disposed adjacent to the user’s left ear by being disposed in the first temple 204, and a first speaker 292-1 disposed adjacent to the user’s right ear by being disposed in the second temple 205.

In an embodiment, the light emitting module may include at least one light emitting element. The light emitting module may emit light of a color corresponding to a specific state or may emit light through an operation corresponding to the specific state in order to visually provide information on a specific state of the wearable device 200 to the user. For example, when the wearable device 200 requires charging, it may repeatedly emit red light at a designated timing. In an embodiment, the light emitting module may be disposed on the first rim 201 and/or the second rim 202.

Referring to FIG. 2B, according to an embodiment, the wearable device 200 may include the printed circuit board (PCB) 290. The PCB 290 may be included in at least one of the first temple 204 or the second temple 205. The PCB 290 may include an interposer disposed between at least two sub PCBs. On the PCB 290, one or more hardware included in the wearable device 200 may be disposed. The wearable device 200 may include a flexible PCB (FPCB) for interconnecting the hardware.

According to an embodiment, the wearable device 200 may include at least one of a gyro sensor, a gravity sensor, and/or an acceleration sensor for detecting the posture of the wearable device 200 and/or the posture of a body part (e.g., a head) of the user wearing the wearable device 200. Each of the gravity sensor and the acceleration sensor may measure gravity acceleration, and/or acceleration based on preset 3-dimensional axes (e.g., x-axis, y-axis, and z-axis) perpendicular to each other. The gyro sensor may measure angular velocity of each of preset 3-dimensional axes (e.g., x-axis, y-axis, and z-axis). At least one of the gravity sensor, the acceleration sensor, and the gyro sensor may be referred to as an inertial measurement unit (IMU). According to an embodiment, the wearable device 200 may identify the user’s motion and/or gesture performed to execute or stop a specific function of the wearable device 200 based on the IMU.

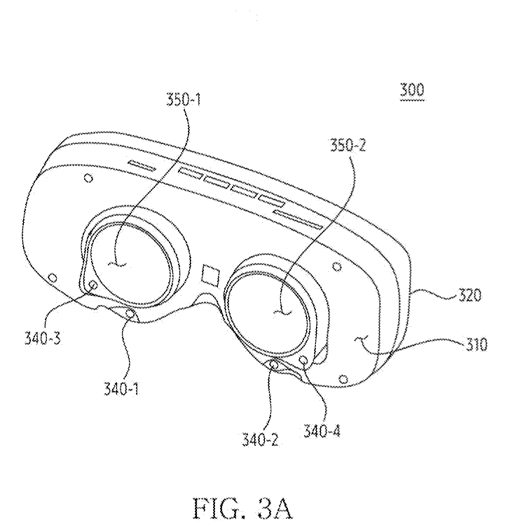

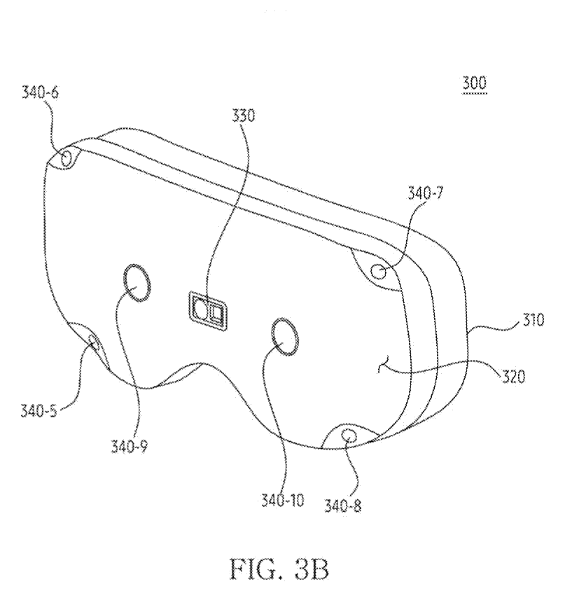

FIGS. 3A to 3B illustrate an example of an exterior of a wearable device 300 according to an embodiment. The wearable device 300 of FIGS. 3A to 3B may be included in the electronic device 101 of FIG. 1. According to an embodiment, an example of an exterior of a first surface 310 of a housing of the wearable device 300 may be illustrated in FIG. 3A, and an example of an exterior of a second surface 320 opposite to the first surface 310 may be illustrated in FIG. 3B.

Referring to FIG. 3A, according to an embodiment, the first surface 310 of the wearable device 300 may have an attachable shape on the user’s body part (e.g., the user’s face). In an embodiment, the wearable device 300 may further include a strap for being fixed on the user’s body part, and/or one or more temples (e.g., the first temple 204 and/or the second temple 205 of FIGS. 2A to 2B). A first display 350-1 for outputting an image to the left eye among the user’s two eyes and a second display 350-2 for outputting an image to the right eye among the user’s two eyes may be disposed on the first surface 310. The wearable device 300 may further include rubber or silicon packing, which are formed on the first surface 310, for preventing interference by light (e.g., ambient light) different from the light emitted from the first display 350-1 and the second display 350-2.

According to an embodiment, the wearable device 300 may include cameras 340-1 and 340-2 for photographing and/or tracking two eyes of the user adjacent to each of the first display 350-1 and the second display 350-2. The cameras 340-1 and 340-2 may be referred to as ET camera. According to an embodiment, the wearable device 300 may include cameras 340-3 and 340-4 for photographing and/or recognizing the user’s face. The cameras 340-3 and 340-4 may be referred to as a FT camera.

Referring to FIG. 3B, a camera (e.g., cameras 340-5, 340-6, 340-7, 340-8, 340-9, and 340-10), and/or a sensor (e.g., the depth sensor 330) for obtaining information associated with the external environment of the wearable device 300 may be disposed on the second surface 320 opposite to the first surface 310 of FIG. 3A. For example, the cameras 340-5, 340-6, 340-7, 340-8, 340-9, and 340-10 may be disposed on the second surface 320 in order to recognize an external object distinct from the wearable device 300. For example, by using cameras 340-9 and 340-10, the wearable device 300 may obtain an image and/or video to be transmitted to each of the user’s two eyes. The camera 340-9 may be disposed on the second surface 320 of the wearable device 300 to obtain an image to be displayed through the second display 350-2 corresponding to the right eye among the two eyes. The camera 340-10 may be disposed on the second surface 320 of the wearable device 300 to obtain an image to be displayed through the first display 350-1 corresponding to the left eye among the two eyes.

According to an embodiment, the wearable device 300 may include the depth sensor 330 disposed on the second surface 320 in order to identify a distance between the wearable device 300 and the external object. By using the depth sensor 330, the wearable device 300 may obtain spatial information (e.g., a depth map) about at least a portion of the FoV of the user wearing the wearable device 300.

In an embodiment, a microphone for obtaining sound outputted from the external object may be disposed on the second surface 320 of the wearable device 300. The number of microphones may be one or more according to embodiments.

As described above, the wearable device 300 according to an embodiment may have a form factor for being worn on a head of the user. In a state of being worn on the head, the wearable device 300 may provide a user experience based on augmented reality, virtual reality, and/or mixed reality. Using the cameras 340-5, 340-6, 340-7, 340-8, 340-9, and 340-10 for recording a video of an external space, the wearable device 300 and a server (e.g., the server 110 of FIG. 1) connected to the wearable device 300 may provide an on-demand service and/or a metaverse service providing a video of a location and/or a place selected by the user.

According to an embodiment, the wearable device 300 may display frames obtained through the cameras 340-9 and 340-10 on each of the first display 350-1 and the second display 350-2. The wearable device 300 may provide the user with a user experience (e.g., video see-through (VST)) in which a real object and a virtual object are mixed, by combining the virtual object in a frame, including the real object, displayed through the first display 350-1 and the second display 350-2. The wearable device 300 may change the virtual object based on information obtained by the cameras 340-1, 340-2, 340-3, 340-4, 340-5, 340-6, 340-7, and 340-8 and/or the depth sensor 330. For example, in a case where a visual object corresponding to the real object and the virtual object are at least partially overlapped in the frame, the wearable device 300 may cease displaying the virtual object based on detecting a motion to interact with the real object. By ceasing displaying the virtual object, the wearable device 300 may prevent visibility of the real object from being reduced, as the visual object corresponding to the real object is occluded by the virtual object.

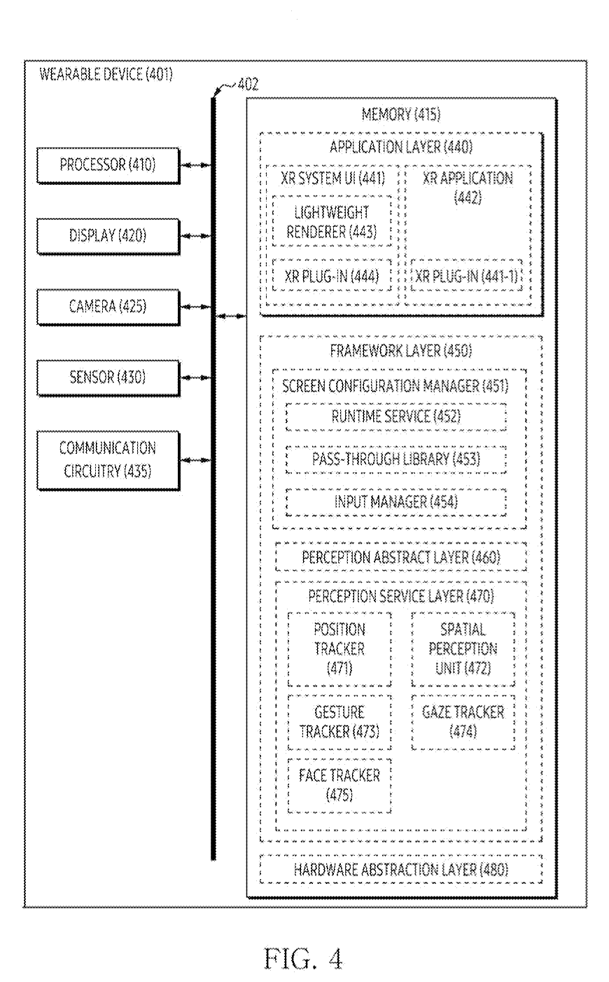

FIG. 4 illustrates an example of a block diagram of a wearable device 401 according to an embodiment. The wearable device 401 of FIG. 4 may correspond to the electronic device 101 of FIG. 1. The wearable device 401 of FIG. 4 may correspond to the wearable device 200 of FIGS. 2A and 2B. The wearable device 401 of FIG. 4 may correspond to the wearable device 300 of FIGS. 3A and 3B.

Referring to FIG. 4, the wearable device 401 according to an embodiment may include at least one of a processor 410, memory 415, a display 420, a camera 425, a sensor 430, or communication circuitry 435. The processor 410 of FIG. 4 may correspond to the processor 120 of FIG. 1. The memory 415 of FIG. 4 may correspond to the memory 130 of FIG. 1. The display 420 of FIG. 4 may correspond to the display module 160 of FIG. 1. The camera 425 of FIG. 4 may correspond to the camera module 180 of FIG. 1. The sensor 430 of FIG. 4 may correspond to the sensor module 176 of FIG. 1. The communication circuitry 435 of FIG. 4 may correspond to the communication module 190 of FIG. 1.

The processor 410, the memory 415, the display 420, the camera 425, the sensor 430, and the communication circuitry 435 may be electronically and/or operably coupled with each other by an electrical component such as a communication bus 402. A type and/or the number of hardware components included in the wearable device 401 is not limited to those illustrated in FIG. 4. For example, the wearable device 401 may include only a part of hardware components illustrated in FIG. 4. Elements (e.g., layers and/or modules) in the memory described below may be in a state of being logically divided. However, the present disclosure is not limited to the above example embodiment.

The processor 410 of the wearable device 401 according to an embodiment may include a hardware component for processing data based on one or more instructions. The hardware component for processing data may include, for example, an arithmetic and logic unit (ALU), a field programmable gate array (FPGA), and/or a central processing unit (CPU). The number of processors 410 may be one or more. For example, the processor 410 may have a structure of a multi-core processor such as a dual core, a quad core, a hexa core, or an octa core.

The memory 415 of the wearable device 401 according to an embodiment may include a hardware component for storing data and/or instructions inputted to and/or outputted from the processor 410. The memory 415 may include, for example, a volatile memory, such as a random-access memory (RAM), and/or a non-volatile memory, such as a read-only memory (ROM). The volatile memory may include, for example, at least one of a dynamic RAM (DRAM), a static RAM (SRAM), a Cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disc, and an embedded multimedia card (eMMC).

In an embodiment, the display 420 of the wearable device 401 may output visualized information to a user of the wearable device 401. For example, the display 420 may output visualized information to the user by being controlled by the processor 410 including circuitry such as a graphic processing unit (GPU). The display 420 may include a flat panel display (FPD) and/or electronic paper. The FPD may include a liquid crystal display (LCD), a plasma display panel (PDP), and/or one or more light emitting diodes (LEDs). The LED may include an organic LED (OLED).

In an embodiment, the camera 425 of the wearable device 401 may include one or more optical sensors (e.g., a charged coupled device (CCD) sensor and a complementary metal oxide semiconductor (CMOS) sensor) that generate an electrical signal indicating a color and/or brightness of light. A plurality of optical sensors included in the camera 425 may be disposed in a form of a two-dimensional array. The camera 425 may generate two-dimensional frame data corresponding to light reaching the optical sensors of the two-dimensional array by obtaining electrical signals of each of the plurality of optical sensors substantially simultaneously. For example, photo data captured using the camera 425 may mean a two-dimensional frame data obtained from the camera 425. For example, video data captured using the camera 425 may mean a sequence of a plurality of two-dimensional frame data obtained from the camera 425 according to a frame rate. The camera 425 may further include a flash light, disposed toward a direction in which the camera 425 receives light, for outputting light toward the direction.

According to an embodiment, the wearable device 401 may include a plurality of cameras disposed toward different directions as an example of the camera 425. Among the plurality of cameras, a first camera may be referred to as a motion recognition camera (e.g., the motion recognition camera 240-2, or the motion recognition camera 340-5, 340-6, 340-7, 340-8, 340-9, or 340-10), and a second camera may be referred to as a gaze tracking camera (e.g., the gaze tracking camera 240-1, or the gaze tracking camera 340-1 or 340-2). The wearable device 401 may identify a position, a shape, and/or a gesture of a hand by using an image obtained using the first camera. The wearable device 401 may identify a direction of a gaze of the user wearing the wearable device 401, by using an image obtained using the second camera. As an example, a direction in which the first camera faces and a direction in which the second camera faces may be opposite to each other.

According to an embodiment, the sensor 430 of the wearable device 401 may generate electronic information that may be processed by the processor 410 and/or the memory 415 of the wearable device 401 from non-electronic information related to the wearable device 401. The information may be referred to as sensor data. The sensor 430 may include a global positioning system (GPS) sensor for detecting a geographic location of the wearable device 401, an image sensor, an illumination sensor, and/or a time-of-flight (ToF) sensor, and an IMU for detecting a physical motion of the wearable device 401.

In an embodiment, the communication circuitry 435 of the wearable device 401 may include a hardware component for supporting transmission and/or reception of an electrical signal between the wearable device 401 and an external electronic device. The communication circuitry 435 may include, for example, at least one of a MODEM, an antenna, or an optic/electronic (O/E) converter. The communication circuitry 435 may support transmission and/or reception of an electrical signal based on various types of protocols, such as Ethernet, local area network (LAN), wide area network (WAN), wireless fidelity (WiFi), Bluetooth™, Bluetooth Low Energy (BLE), ZigBee, long term evolution (LTE), 5G new radio (NR), and/or 6G.

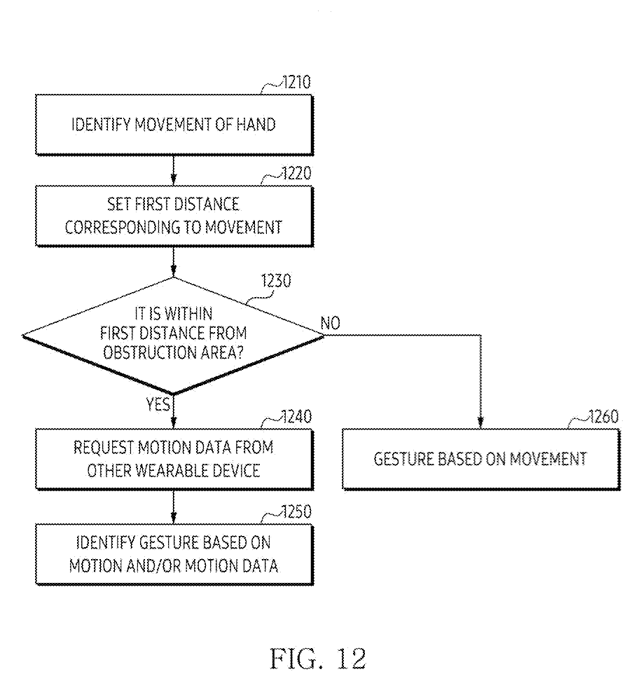

According to an embodiment, in the memory 415 of the wearable device 401, one or more instructions (or commands) indicating a calculation and/or an operation to be performed on data by the processor 410 of the wearable device 401 may be stored. A set of one or more instructions may be referred to as firmware, an operating system, a process, a routine, a sub-routine and/or an application. For example, the wearable device 401 and/or processor 410 may perform at least one of operations of FIGS. 12 to 14, when a set of a plurality of instructions distributed in a form of an operating system, firmware, a driver, and/or an application is executed. Hereinafter, an application being installed in the wearable device 401 may mean that one or more instructions provided in a form of an application are stored in the memory 415, and that the one or more applications are stored in a format (e.g., a file having an extension designated by an operating system of the wearable device 401) executable by the processor 410. As an example, an application may include a program and/or a library related to a service provided to the user.

Referring to FIG. 4, programs installed in the wearable device 401 may be classified, based on a target, into any one layer among different layers including an application layer 440, a framework layer 450, and/or a hardware abstraction layer (HAL) 480. For example, in the hardware abstraction layer 480, programs (e.g., a module or a driver) designed to target hardware (e.g., the display 420, the camera 425, and/or the sensor 430) of the wearable device 401 may be classified. The framework layer 450 may be referred to as an XR framework layer in terms of including one or more programs for providing an extended reality (XR) service. For example, although FIG. 4 illustrates layers divided in the memory 415, the layers may be logically divided. However, the present disclosure is not limited to the above example embodiment. According to an embodiment, the layers may be stored in a designated area in the memory 415.

For example, in the framework layer 450, programs (e.g., a position tracker 471, a spatial perception unit 472, a gesture tracker 473, a gaze tracker 474, and/or a face tracker 475) designed to target at least one of the hardware abstraction layer 480 and/or the application layer 440 may be classified. The programs classified as the framework layer 450 may provide an application programming interface (API) executable based on another program.

For example, in the application layer 440, a program designed to target the user controlling the wearable device 401 may be classified. As an example of the programs classified as the application layer 440, an extended reality (XR) system user interface (UI) and/or an XR application 442 are exemplified, but an embodiment is not limited thereto. For example, the programs (e.g., a software application) classified as the application layer 440 may cause execution of a function supported by the programs classified as the framework layer 450 by calling an application programming interface (API).

For example, based on execution of the XR system UI 441, the wearable device 401 may display, on the display 420, one or more visual objects to perform interaction with a user for using a virtual space. The visual object may mean an object deployable in a screen for transmission of information and/or interaction, such as text, an image, an icon, a video, a button, a checkbox, a radio button, a text box, a slider, and/or a table. The visual object may be referred to as a visual guide, a virtual object, a visual element, a UI element, a view object, and/or a view element. The wearable device 401 may provide functions available in the virtual space to the user based on the execution of the XR system UI 441.

FIG. 4 illustrates that a lightweight renderer 443 and/or an XR plug-in 444 are included in the XR system UI 441, but is not limited thereto. For example, the XR system UI 441 may cause execution of a function supported by the lightweight renderer 443 and/or the XR plug-in 444 included in the framework layer 450.

For example, the wearable device 401 may obtain a resource (e.g., an API, a system process, and/or a library) used to define, generate, and/or execute a rendering pipeline in which a partial change is allowed, based on execution of the lightweight renderer 443. The lightweight renderer 443 may be referred to as a lightweight render pipeline in terms of defining the rendering pipeline in which the partial change is allowed. The lightweight renderer 443 may include a renderer (e.g., a prebuilt renderer) built before execution of a software application. For example, the wearable device 401 may obtain a resource (e.g., an API, a system process, and/or a library) used to define, generate, and/or execute an entire rendering pipeline based on execution of the XR plug-in 444. The XR plug-in 444 may be referred to as an open XR native client in terms of defining (or setting) the entire rendering pipeline.

For example, the wearable device 401 may display, on the display 420, a screen indicating at least a part of the virtual space based on execution of the XR application 442. An XR plug-in 444-1 included in the XR application 442 may be referred to as the XR plug-in 444 of the XR system UI 441. Among descriptions of the XR plug-in 444-1, descriptions overlapping descriptions of the XR plug-in 444 may be omitted. The wearable device 401 may cause execution of a virtual space manager 451 based on execution of the XR application 442.

According to an embodiment, the wearable device 401 may provide a virtual space service based on the execution of the virtual space manager 451. For example, the virtual space manager 451 may include a platform (e.g., an Android platform) for supporting the virtual space service. Based on the execution of the virtual space manager 451, the wearable device 401 may display, on the display, a posture of a virtual object indicating a posture of the user rendered by using data obtained through the sensor 430. The virtual space manager 451 may be referred to as a composition presentation manager (CPM).

For example, the virtual space manager 451 may include a runtime service 452. As an example, the runtime service 452 may be referred to as an OpenXR runtime module. Based on execution of the runtime service 452, the wearable device 401 may be used to provide at least one of a user pose prediction function, a frame timing function, and/or a spatial input function through the wearable device 401. As an example, the wearable device 401 may be used to perform rendering for the virtual space service to the user based on the execution of the runtime service 452. For example, based on the execution of the runtime service 452, an application (e.g., unity or OpenXR native application) may be implemented.

For example, the virtual space manager 451 may include a pass-through manager 453. Based on execution of the pass-through manager 453, in an overlapping manner, the wearable device 401 may display another screen indicating a real space obtained through the camera 425 on at least a part of a screen while displaying the screen indicating a virtual space on the display 420.

For example, the virtual space manager 451 may include an input manager 454. Based on execution of the input manager 454, the wearable device 401 may identify data (e.g., sensor data) obtained by executing one or more programs included in a perception service layer 470. The wearable device 401 may initiate execution of at least one of functions of the wearable device 401 by using the obtained data.

For example, the perception abstract layer 460 may be used for data exchange between the virtual space manager 451 and the perception service layer 470. In terms of being used for data exchange between the virtual space manager 451 and the perception service layer 470, the perception abstract layer 460 may be referred to as an interface. As an example, the perception abstract layer 460 may be referenced as OpenPX. The perception abstract layer 460 may be used for a perception client and a perception service.

According to an embodiment, the perception service layer 470 may include one or more programs for processing data obtained from the sensor 430 (e.g., the camera 425). The one or more programs may include at least one of the position tracker 471, the spatial perception unit 472, the gesture tracker 473, the gaze tracker 474, and/or the face tracker 475. A type and/or the number of the one or more programs included in the perception service layer 470 is not limited to those illustrated in FIG. 4.

For example, based on execution of the position tracker 471, the wearable device 401 may identify a posture of the wearable device 401 using the sensor 430. Based on the execution of the position tracker 471, the wearable device 401 may identify a 6 degrees of freedom pose (6 dof pose) of the wearable device 401 by using data obtained using the camera 425 and the IMU. The position tracker 471 may be referred to as a head tracking (HeT) module.

For example, based on execution of the spatial perception unit 472, the wearable device 401 may be used to configure a surrounding environment of the wearable device 401 (or the user of the wearable device 401) into a three-dimensional virtual space. Based on the execution of the spatial perception unit 472, the wearable device 401 may reconstruct the surrounding environment of the wearable device 401 in three dimensions by using data obtained using the camera 425. The wearable device 401 may identify at least one of a plane, an inclination, and a step based on the surrounding environment of the wearable device 401 reconstructed in three dimensions based on the execution of the spatial perception unit 472. The spatial perception unit 472 may be referred to as a scene understanding (SU) module.

For example, based on execution of the gesture tracker 473, the wearable device 401 may be used to identify (or perceive) a pose and/or a gesture of the hand of the user of the wearable device 401. As an example, based on the execution of the gesture tracker 473, the wearable device 401 may identify the pose and/or the gesture of the hand of the user by using data obtained from the sensor 430 and/or the camera 425. As an example, based on the execution of the gesture tracker 473, the wearable device 401 may identify the pose and/or the gesture of the hand of the user based on data (or an image) obtained using the camera. The gesture tracker 473 may be referred to as a hand tracking (HaT) module and/or a gesture tracking module.

For example, the wearable device 401 may identify (or track) a movement of an eye of the user of the wearable device 401 based on execution of the gaze tracker 474. As an example, the wearable device 401 may identify the movement of the eye of the user by using data obtained from at least one sensor based on the execution of the gaze tracker 474. As an example, the wearable device 401 may identify the movement of the eye of the user based on data obtained using a camera (e.g., the gaze tracking camera 260-1 of FIGS. 2A and 2B) and/or an infrared light emitting diode (IR LED) based on the execution of the gaze tracker 474. The gaze tracker 474 may be referred to as an eye tracking (ET) module and/or a gaze tracking module.

For example, the perception service layer 470 of the wearable device 401 may further include the face tracker 475 for tracking a face of the user. For example, the wearable device 401 may identify (or track) a movement of the face of the user and/or facial expression of the user based on execution of the face tracker 475. Based on the execution of the face tracker 475, the wearable device 401 may estimate the facial expression of the user. As an example, based on the execution of the face tracker 475, the wearable device 401 may identify the movement of the face of the user and/or the facial expression of the user based on data (e.g., an image) obtained using a camera.

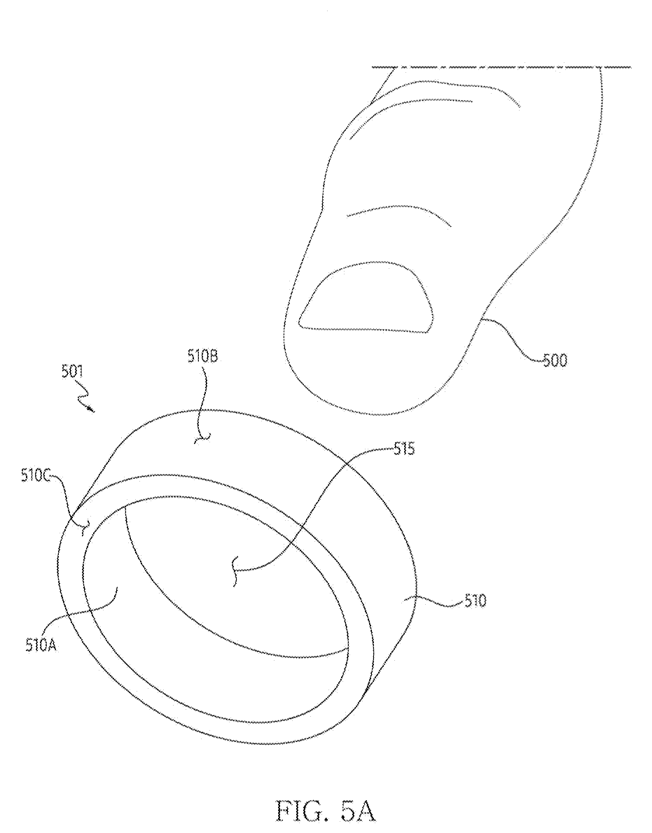

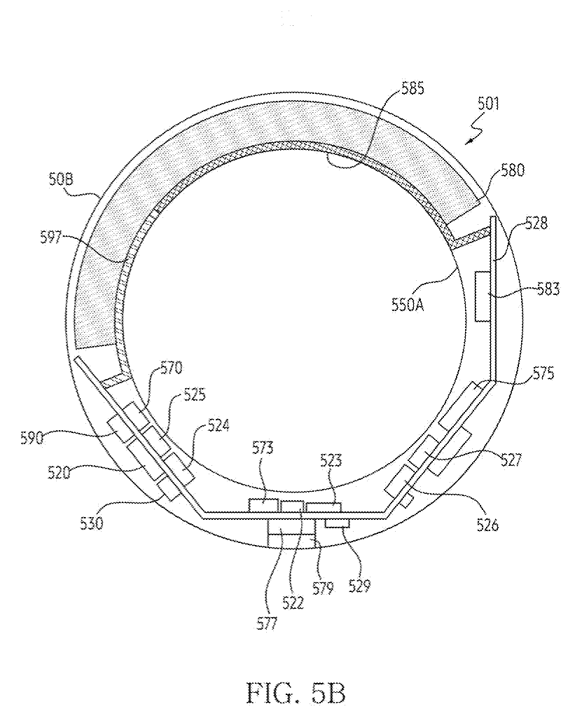

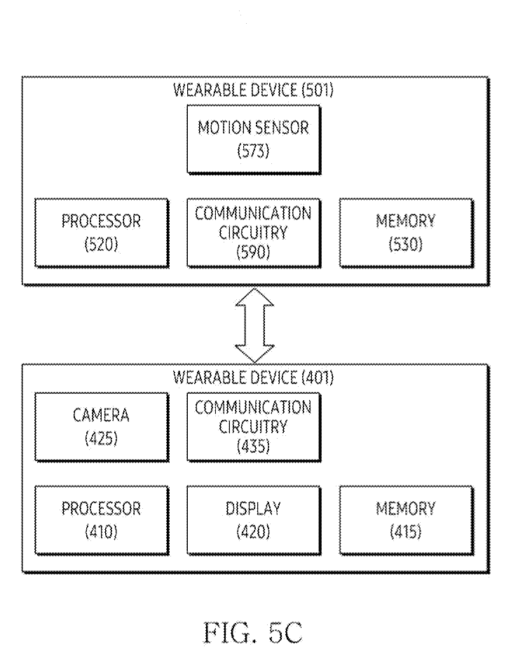

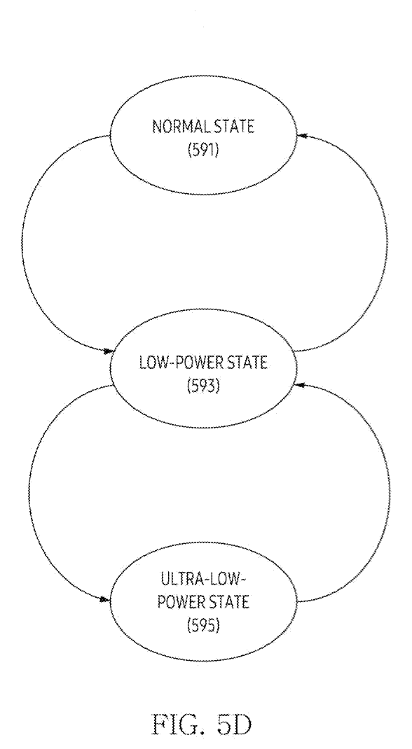

FIG. 5A illustrates an exemplary wearable device according to an embodiment. FIG. 5B represents a cross-section of an exemplary wearable device according to an embodiment. FIG. 5C is a block diagram of an exemplary wearable device according to an embodiment. FIG. 5D is a state transition diagram of an exemplary wearable device according to an embodiment.

A wearable device 401 of FIG. 5C may correspond to the wearable device 401 of FIG. 4. A processor 410 of FIG. 5C may correspond to the processor 410 of FIG. 4. A memory 415 of FIG. 5C may correspond to the memory 415 of FIG. 4. A display 420 of FIG. 5C may correspond to the display 420 of FIG. 4. A camera 425 of FIG. 5C may correspond to the camera 425 of FIG. 4. Communication circuitry 435 of FIG. 5C may correspond to the communication circuitry 435 of FIG. 4.

Referring to FIGS. 5A and 5B, a wearable device 501 according to an embodiment may be configured to be wearable by a user. For example, the wearable device 501 may have a ring shape in which a hole 515 is provided so that the user may insert a body (or a part of the body) 500 (e.g., a finger). However, it is not limited thereto, and the wearable device 501 may have various shapes corresponding to the body in order to be worn on the body of the user.

In an embodiment, the wearable device 501 may include a housing 510.

Referring to FIG. 5A, the housing 510 may form an exterior of the wearable device 501. For example, the housing 510 may form or define a first surface 510A, a second surface 510B, and a third surface 510C. When the user wears the wearable device 501, the first surface 510A may surround a body of the user so as to face the body 500 of the user. The first surface 510A may at least partially contact the body 500 of the user. The second surface 510B may be spaced apart from the first surface 510A and may face an opposite direction to the first surface 510A. The third surface 510C may surround a space between the first surface 510A and the second surface 510B. For example, the third surface 510C may extend from a periphery of the first surface 510A to a periphery of the second surface 510B. A hole 515 defined by the first surface 510A may be formed in the housing 510 to accommodate the body 500 of the user. The first surface 510A may be referred to as an inner circumferential surface, and the second surface 510B may be referred to as an outer circumferential surface.

Referring to FIG. 5B, the wearable device 501 may include at least one light emitting unit 522, 524, and/or 526 and at least one light receiving unit 523, 525, and/or 527. In an embodiment, the wearable device 501 may include a substrate 528. In an embodiment, the wearable device 501 may include a processor 520, a controller 529, memory 530, a temperature sensor 570, a motion sensor 573, a pressure sensor 575, an external temperature sensor 577, a lens 579, a battery 580, a power management module 583, a charging interface 585, communication circuitry 590, and an antenna 597.

In an embodiment, the substrate 528 may include a flexible printed circuit board or a rigid-flexible printed circuit board. For example, the substrate 528 may be at least partially bent. For example, the substrate 528 may include a curved part to correspond to a curvature of the first surface 510A having a ring shape.

In an embodiment, the processor 520 may correspond to the processor 120 of FIG. 1. In an embodiment, the controller 529 may be included in the sensor module 176 of FIG. 1. In an embodiment, the memory 530 may correspond to the memory 130 of FIG. 1. In an embodiment, each of the at least one light emitting unit 522, 524, and/or 526, the at least one light receiving unit 523, 525, and/or 527, the temperature sensor 570, the motion sensor 573, the pressure sensor 575, and the external temperature sensor 577 may correspond to the sensor module 176 of FIG. 1. In an embodiment, the battery 580 may correspond to the battery 189 of FIG. 1. In an embodiment, the power management module 583 may correspond to the power management module 188 of FIG. 1. In an embodiment, the communication circuitry 590 may correspond to the communication module 190 of FIG. 1. In an embodiment, the antenna 597 may correspond to the antenna module 197 of FIG. 1. In an embodiment, the charging interface 585 may include wired and/or wireless interface circuitry for receiving power from an external power source to charge the battery 580.

In an embodiment, the at least one light emitting unit 522, 524, and/or 526 and the at least one light receiving unit 523, 525, and/or 527 may also be referred to as a photo plethysmography (PPG) sensor. However, the present disclosure is not limited to the above example embodiment. In an embodiment, the at least one light emitting unit 522, 524, and/or 526 and the at least one light receiving unit 523, 525, and/or 527 may also be referred to as a proximity sensor.

In an embodiment, the at least one light emitting unit 522, 524, and/or 526 and the at least one light receiving unit 523, 525, and/or 527 may be disposed on the substrate 528. For example, the at least one light emitting unit 522, 524, and/or 526 may be disposed on the substrate 528 to face the first surface 510A. For example, the at least one light receiving unit 523, 525, and/or 527 may be disposed on the substrate 528 to face the first surface 510A.

In an embodiment, the motion sensor 573 may include an acceleration sensor and/or a gyro sensor. For example, the motion sensor 573 may be a three-axis sensor (e.g., the acceleration sensor). For example, the motion sensor 573 may be a 6-axis sensor (e.g., the acceleration sensor and the gyro sensor).

In an embodiment, the motion sensor 573 may include at least one of a gyro sensor, a gravity sensor, and/or an acceleration sensor for detecting a posture of the wearable device 501 and/or a motion of the wearable device 501. Each of the gravity sensor and the acceleration sensor may measure gravitational acceleration and/or acceleration based on designated three-dimensional axes (e.g., an x-axis, a y-axis, and a z-axis) perpendicular to each other. The gyro sensor may measure angular velocity of each of the designated three-dimensional axes (e.g., the x-axis, the y-axis, and the z-axis). At least one of the gravity sensor, the acceleration sensor, and the gyro sensor may be referred to as an IMU.

In an embodiment, the pressure sensor 575 may be disposed on the substrate 528 to face the first surface 510A. In an embodiment, the pressure sensor 575 may measure a pressure value applied to at least a part of the first surface 510A.

In an embodiment, the external temperature sensor 577 may be disposed on the substrate 528 to face the second surface 510B. The external temperature sensor 577 may measure a temperature of a temperature measurement target based on infrared radiation emitted by the temperature measurement target. In an embodiment, the lens 579 for transmitting the infrared radiation may be provided so that the infrared radiation emitted by the temperature measurement target may be received by the external temperature sensor 577. The lens 579 may be disposed to face the second surface 510B.

Referring to FIG. 5C, a wearable device 501 may include a processor 520, memory 530, a motion sensor 573, and communication circuitry 590.

The wearable device 501 may correspond to the electronic device 102 of FIG. 1. However, the present disclosure is not limited to the above example embodiment. For example, the wearable device 501 may correspond to the electronic device 101 of FIG. 1. The processor 520 of FIG. 5C may correspond to the processor 520 of FIG. 5B. The memory 530 of FIG. 5C may correspond to the memory 530 of FIG. 5B. The motion sensor 573 of FIG. 5C may correspond to the motion sensor 573 of FIG. 5B. The communication circuitry 590 of FIG. 5C may correspond to the communication circuitry 590 of FIG. 5B.

In an embodiment, the processor 520 may establish a communication connection with the wearable device 401 through the communication circuitry 590. Herein, the wearable device 401 may be various types of devices. For example, the wearable device 401 may be AR glasses and/or a HMD. For example, the wearable device 401 may be a portable communication device (e.g., a smartphone), a computer device, a portable multimedia device, a portable medical device, a camera, a wearable device (e.g., a watch), or a home appliance.

In an embodiment, the processor 520 may receive a request for motion data from the wearable device 401 through the communication circuitry 590. Here, the motion data may include gravitational acceleration, acceleration, and/or angular velocity in each of designated three-dimensional axes (e.g., an x-axis, a y-axis, and a z-axis) perpendicular to each other, obtained through the motion sensor 573.

In an embodiment, the processor 520 may transmit the motion data to the wearable device 401 through the communication circuitry 590. In an embodiment, the processor 520 may transmit the motion data to the wearable device 401 in response to the request for the motion data of the wearable device 401.

In an embodiment, the wearable device 401 may identify a gesture of a user 500 within a field-of-view (FOV) of the camera 425 identified through the camera 425. In an embodiment, the wearable device 401 may identify a gesture of the user 500 based on the motion data from the wearable device 501.

Referring to FIG. 5D, a wearable device 501 may have one state among a plurality of states 591, 593, and 595. The wearable device 501 may have one state among a normal state 591, a low-power state 593, or an ultra-low-power state 595.

The wearable device 501 may transition from one state among the plurality of states 591, 593, and 595 to another state. For example, the wearable device 501 may transition from the normal state 591 to the low-power state 593 or the ultra-low-power state 595. For example, the wearable device 501 may transition from the low-power state 593 to the normal state 591 or the ultra-low-power state 595. For example, the wearable device 501 may transition from the ultra-low-power state 595 to the normal state 591 or the low-power state 593.

In an embodiment, in the normal state 591, at least a part of components of the wearable device 501 may be in an active state. For example, in the normal state 591, the processor 520, the motion sensor 573, and the communication circuitry 590 may be in the active state. For example, in the normal state 591, the processor 520 may process motion data through the motion sensor 573. For example, in the normal state 591, the processor 520 may obtain data from the communication circuitry 590 and/or transmit data to the communication circuitry 590. For example, in the normal state 591, the motion sensor 573 may obtain the motion data. For example, in the normal state 591, the communication circuitry 590 may be communicatively connected to the communication circuitry 435 of the wearable device 401. For example, in the normal state 591, the communication circuitry 590 may transmit and receive a data packet and/or a control packet in an allocated time slot through the communication connection with the communication circuitry 435. For example, in the normal state 591, the communication circuitry 590 may periodically receive a synchronization signal through a communication channel with the communication circuitry 435 for synchronization with the communication circuitry 435.

In an embodiment, in the low-power state 593, at least a part of the components of the wearable device 501 may be in an inactive state. For example, in the low-power state 593, the processor 520 and the motion sensor 573 may be in the inactive state. For example, in the low-power state 593, the processor 520 may not process the motion data through the motion sensor 573. Herein, not processing the motion data may include that the processor 520 does not obtain the motion data from the motion sensor 573. For example, in the low-power state 593, the processor 520 may not obtain data from the communication circuitry 590. For example, in the low-power state 593, the processor 520 may not transmit data to the communication circuitry 590. For example, in the low-power state 593, the motion sensor 573 may not obtain the motion data.

In an embodiment, in the low-power state 593, the communication circuitry 590 may be in a sleep state. For example, in the low-power state 593, the communication circuitry 590 may be in a state in which the communication connection with the communication circuitry 435 of the wearable device 401 has been established. For example, in the low-power state 593, the communication circuitry 590 may be in a state of not exchanging a data packet and/or a control packet with each other through the communication connection with the communication circuitry 435 of the wearable device 401. In an embodiment, in the low-power state 593, the communication circuitry 590 may transition from the sleep state to the active state by a wake-up signal from the communication circuitry 435.

In an embodiment, in the ultra-low-power state 595, the components of the wearable device 501 may be in an inactive state. For example, in the ultra-low-power state 595, the processor 520, the motion sensor 573, and the communication circuitry 590 may be in the inactive state. For example, in the ultra-low-power state 595, the communication circuitry 590 may not be in a state of not being communicatively connected to the communication circuitry 435 of the wearable device 401. For example, in the ultra-low-power state 595, the communication circuitry 590 may be in a standby state. For example, in the standby state, the communication circuitry 590 may not transmit or receive data. In an embodiment, in the ultra-low-power state 595, the communication circuitry 590 may pair (or establish the communication connection) with the communication circuitry 435 based on a pairing request (or a communication connection request) from the communication circuitry 435. In an embodiment, in the ultra-low-power state 595, the communication circuitry 590 may transition from the standby state after pairing (or communication connection) with the communication circuitry 435 to a sleep state (or an active state).

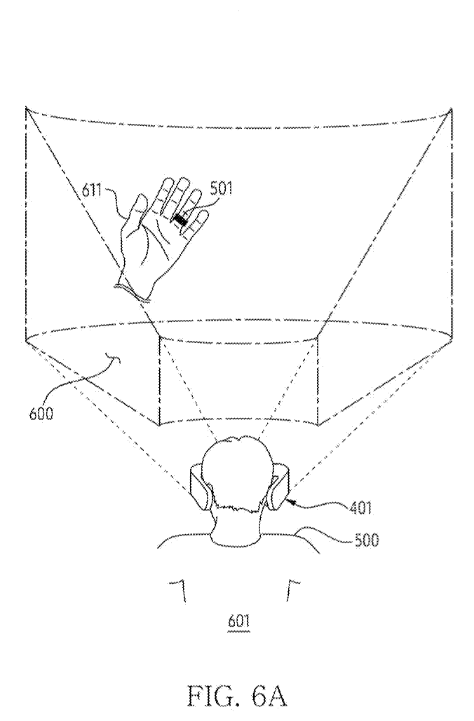

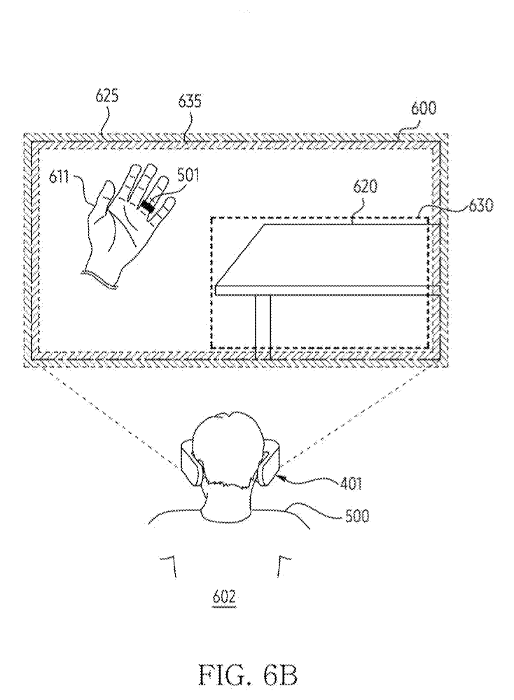

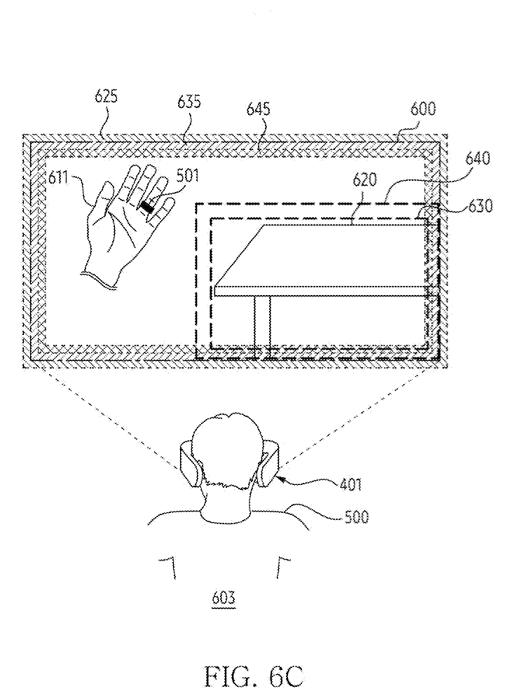

In an embodiment, the wearable device 401 may determine whether to request the motion data from the wearable device 501 based on a state of the wearable device 401 and/or a state of the wearable device 501. Hereinafter, an operation in which the wearable device 401 determines whether to request the motion data from the wearable device 501 based on the state of the wearable device 401 and/or the state of the wearable device 501 will be described with reference to FIGS. 6B, 6C, 7A, 7B, 8, 9, 10, and 11.

FIG. 6A illustrates an example 601 of a FOV 600 obtained through a camera 425 of a wearable device 401 worn by a user 500 in an embodiment.

A wearable device 401 of FIG. 6A may correspond to the electronic device 101 of FIG. 1. The wearable device 401 of FIG. 6A may correspond to the wearable device 200 of FIGS. 2A and 2B. The wearable device 401 of FIG. 6A may correspond to the wearable device 300 of FIGS. 3A and 3B. The wearable device 401 of FIG. 6A may correspond to the wearable device 401 of FIG. 4. A wearable device 501 of FIG. 6A may correspond to the wearable device 501 of FIGS. 5A, 5B, and 5C. FIG. 6A may be described with reference to FIGS. 1, 2A, 2B, 3A, 3B, 4, 5A, 5B, 5C, and 5D.

Referring to FIG. 6A, the user 500 may wear the wearable device 401. In an embodiment, the wearable device 401 may obtain an image with respect to the FOV 600 of the camera 425 through the camera 425. In an embodiment, the wearable device 401 may obtain an image representing an actual space obtained through the camera 425 (or the front camera 240-3, 340-9, or 340-10). In an embodiment, the wearable device 401 may obtain an image representing a space in front of the user 500 through the camera 425.

In an embodiment, the image representing the space in front of the user 500 obtained through the camera 425 may be displayed through a display 420. For example, in order to provide a video see-through (VST) and/or a pass-through environment to the user 500 wearing the wearable device 401, the wearable device 401 may display, through the display 420, the image representing the space in front of the user 500 obtained through the camera 425. For example, in order to provide the user 500 wearing the wearable device 401 with augmented reality (AR) or mixed reality (VR) that mixes the augmented reality (AR) and virtual reality (VR), the wearable device 401 may display, through the display 420, the image representing the space in front of the user 500 obtained through the camera 425. However, the present disclosure is not limited to the above example embodiment. In an embodiment, the image representing the space in front of the user 500 obtained through the camera 425 may not be displayed through the display 420. For example, the wearable device 401 may display, through the display 420, a screen that is not related to the space in front of the user 500. For example, in order to provide virtual reality (VR) that is not related to the space in front of the user 500, the wearable device 401 may display, through the display 420, a screen generated by a program 140 executed by the processor 410.

In an embodiment, the wearable device 401 may recognize one or more objects around the wearable device 401 based on an image obtained through the camera 425. Herein, object recognition may include an operation for identifying one or more objects within the FOV 600 of the wearable device 401. The object recognition may include an operation of identifying objects included in an image obtained through the camera 425 (e.g., a red, green, and blue (RGB) camera, a stereo camera, a time of flight (TOF) camera (or a depth camera)) and classifying the identified objects into objects of a similar pattern.

In an embodiment, a surrounding environment of the wearable device 401 may be recognized. Herein, scene understanding (SU) may include an operation for configuring the surrounding environment of the wearable device 401 (or the user 500 of the wearable device 401) into a three-dimensional virtual space. The scene understanding may include an operation for reconstructing the surrounding environment of the wearable device 401 in three dimensions using an image obtained using the camera 425 (e.g., the RGB camera, the stereo camera, and/or a light detection and ranging (LiDAR) sensor).

In an embodiment, the wearable device 401 may identify one or more objects 501 and 611 within the FOV 600 of the camera 425. In an embodiment, the wearable device 401 may identify the one or more objects 501 and 611 within the FOV 600 of the camera 425 based on object recognition and/or scene understanding. In an embodiment, the one or more objects 501 and 611 may include the wearable device 501. In an embodiment, the one or more objects 501 and 611 may include a hand 611 of the user 500. In an embodiment, the hand 611 may be a hand of the user 500 wearing the wearable device 501. However, the present disclosure is not limited to the above example embodiment. The hand 611 may be a hand of the user 500 who does not wear the wearable device 501 or a hand of another person other than the user 500.

In an embodiment, in a case where the hand 611 of the user 500 is not identified in the FOV 600 of the camera 425, the wearable device 401 may provide a guide for moving the hand 611 of the user 500 into the FOV 600. For example, in a case where the hand 611 of the user 500 is not identified in the FOV 600 of the camera 425, the wearable device 401 may display, through the display 420, the guide for moving the hand 611 of the user 500 into the FOV 600. However, the present disclosure is not limited to the above example embodiment.

In an embodiment, in a case where the wearable device 501 is not identified in the FOV 600 of the camera 425, the wearable device 401 may provide a guide for wearing the wearable device 501 on the hand 611 of the user 500. For example, in a case where the wearable device 501 is not identified in the FOV 600 of the camera 425, the wearable device 401 may display, through the display 420, the guide for wearing the wearable device 501 on the hand 611 of the user 500. However, the present disclosure is not limited to the above example embodiment.

In an embodiment, the wearable device 401 may identify a movement (or a movement trajectory) of the hand 611. In an embodiment, the wearable device 401 may identify a movement of the hand 611 within the FOV 600 of the camera 425. In an embodiment, the wearable device 401 may identify a relative movement of the hand 611. Herein, the relative movement may include a direct movement of the hand 611, a movement of the hand 611 relative to the FOV 600 according to a movement of the wearable device 401, and/or a movement of the hand 611 relative to an object according to a movement of the object within the FOV 600. In an embodiment, the movement of the hand 611 may be identified based on a movement direction and/or movement speed of the hand 611. In an embodiment, the relative movement of the hand 611 may be identified based on a relative movement direction and/or relative movement speed with respect to an arbitrary target (e.g., the FOV 600 and/or an object) of the hand 611.

Hereinafter, an operation in which the wearable device 401 determines whether to request motion data from the wearable device 501 will be described with reference to FIGS. 6A, 6B, 6C, 7A, 7B, 8, 9, 10, and 11.

FIG. 6B illustrates an example of a situation 602 in which a user wearing a wearable device moves a hand in an embodiment.

A wearable device 401 of FIG. 6B may correspond to the electronic device 101 of FIG. 1. The wearable device 401 of FIG. 6B may correspond to the wearable device 200 of FIGS. 2A and 2B. The wearable device 401 of FIG. 6B may correspond to the wearable device 300 of FIGS. 3A and 3B. The wearable device 401 of FIG. 6B may correspond to the wearable device 401 of FIG. 4. A wearable device 501 of FIG. 6B may correspond to the wearable device 501 of FIGS. 5A, 5B, and 5C. FIG. 6B may be described with reference to FIGS. 1, 2A, 2B, 3A, 3B, 4, 5A, 5B, 5C, and 5D.

Compared with FIG. 6A, FIG. 6B may illustrate a FOV 600 of a camera 425 from three dimensions to two dimensions.

In an embodiment, the wearable device 401 may be in a state (or in a paired state) in which a communication connection with the wearable device 501 has been established. In an embodiment, the wearable device 401 may be in the state (or in the paired state) in which the communication connection with the wearable device 501 has been established based on a result of object recognition and/or scene understanding. For example, the wearable device 401 may establish the communication connection with the wearable device 501 based on the number of objects obstructing identification of a hand 611 in the FOV 600 or a probability of the obstruction. For example, the wearable device 401 may establish the communication connection with the wearable device 501 based on the number of objects obstructing the identification of the hand 611 in the FOV 600 being greater than or equal to a designated number or the probability of the obstruction being greater than or equal to a designated probability. In an embodiment, the probability of the obstruction may be determined based on an artificial intelligence model trained to calculate a probability of the obstruction based on a type of object. In an embodiment, the artificial intelligence model may be reinforcement-learned to calculate the probability of the obstruction updated according to whether it is actually occluded by a movement of the hand 611 of a user 500 of the wearable device 401. However, the present disclosure is not limited to the above example embodiment. In an embodiment, the probability of the obstruction may be determined based on the artificial intelligence model trained to calculate the probability of the obstruction based on a distance between an object and the hand 611 and/or a disposition of the object within the FOV 600.

In an embodiment, the wearable device 401 may be in the state (or in the paired state) in which the communication connection with the wearable device 501 has been established based on a type of an application 146 being executed. For example, the wearable device 401 may establish the communication connection with the wearable device 501 based on the application 146 being executed being an application of a type that requires a gesture input (e.g., a game application). In an embodiment, the wearable device 501 may be operating in a low-power state 593. In an embodiment, the wearable device 501 may transition from an ultra-low-power state 595 to the low-power state 593. In an embodiment, the wearable device 401 may be in the state (or in the paired state) in which the communication connection with the wearable device 501 has been established based on a state-of-charge (SOC) of a battery 580 of the wearable device 501. For example, the wearable device 401 may establish the communication connection with the wearable device 501 based on the SOC of the battery 580 of the wearable device 501 being greater than or equal to a designated first SOC (e.g., 60%).

Referring to FIG. 6B, the wearable device 401 may obtain, through the camera 425, an image with respect to the FOV 600 of the camera 425. In an embodiment, the wearable device 401 may perform object recognition and/or scene understanding based on the image obtained through the camera 425. In an embodiment, the wearable device 401 may identify one or more objects 501, 611, and 620 within the FOV 600 of the camera 425 based on object recognition and/or scene understanding.

In an embodiment, the wearable device 401 may identify one or more obstruction areas 620 and 630. In an embodiment, the obstruction areas 620 and 625 may be areas in which the hand 611 (or a finger) is not identified through the FOV 600 of the camera 425. For example, the obstruction area 620 may be an area of an obstruction object (e.g., a desk), among objects within the FOV 600, that may occlude the hand 611 (or the finger) according to a movement of the hand 611 (or the finger). For example, the obstruction area 625 may be an area outside the FOV 600. Herein, the obstruction object (e.g., the desk) occluding the hand 611 (or the finger) may mean that the obstruction object (e.g., the desk) is located between the hand 611 (or the finger) and the camera 425.

In an embodiment, the wearable device 401 may identify a movement (or a movement trajectory) of the hand 611. In an embodiment, the wearable device 401 may identify a movement of the hand 611 within the FOV 600 of the camera 425. In an embodiment, the wearable device 401 may identify a relative movement of the hand 611. Herein, the relative movement may include a direct movement of the hand 611, a movement of the hand 611 relative to the FOV 600 according to a movement of the wearable device 401, and/or a movement of the hand 611 relative to an object according to a movement of the object within the FOV 600. Hereinafter, the movement of the hand 611 and the relative movement of the hand 611 may be referred to as a movement of the hand 611.

In an embodiment, the wearable device 401 may identify (or set) a distance based on the movement of the hand 611. In an embodiment, the wearable device 401 may identify a distance from the obstruction areas 620 and 625 based on the movement of the hand 611. In an embodiment, the wearable device 401 may identify a distance reachable by the hand 611 within a designated first time in the obstruction areas 620 and 625 according to the movement of the hand 611. In an embodiment, the wearable device 401 may set a distance from each of the obstruction areas 620 and 625 based on positions reachable within a designated time in the obstruction areas 620 and 625, based on a movement direction and/or movement speed of the hand 611. Hereinafter, the distance reachable by the hand 611 within the designated first time in the obstruction areas 620 and 625 according to the movement of the hand 611 may be referred to as a first distance. In an embodiment, the first time may be determined based on a processing delay time. In an embodiment, the first time may be determined based on a time required for the wearable device 501 to transmit motion data to the wearable device 401. For example, the first time may include a delay time by a network between the wearable device 401 and the wearable device 501. For example, the first time may include a delay time for processing motion data of the wearable device 401 and/or the wearable device 501. For example, the first time may include the delay time by the network and the delay time for processing the motion data. For example, the first time may be greater than or equal to a time including the delay time by the network and the delay time for processing the motion data. Herein, the delay by the network may include a delay by data transmission and reception between the wearable device 401 and the wearable device 501. The delay by the network may include a delay for a linkage between one or more processors for distributed processing between the one or more processors included in a processor 410 of the wearable device 401. In an embodiment, the delay by the network may be identified based on a network state and through-put information of the network between the wearable device 401 and the wearable device 501. Herein, the delay for processing data may include a delay by resource occupation by one or more tasks of a processor 410 of the wearable device 401. The delay for processing data may include a delay by resource occupation by one or more tasks of a processor 520 of the wearable device 501. In an embodiment, the delay for processing data may be based on a time required through an operation flow to recognize a gesture based on motion data in the wearable device 401. For example, the operation flow may include an operation of obtaining the image with respect to the FOV 600 of the camera 425, an operation of identifying the movement of the hand 611 in the image, and an operation of identifying a gesture based on the movement of the hand 611. For example, the operation flow may include an operation in which the wearable device 501 obtains motion data through a motion sensor 573, an operation in which the wearable device 501 transmits the motion data to the wearable device 401, an operation in which the wearable device 401 identifies a motion of the wearable device 501 based on the motion data, and an operation of identifying a gesture based on the motion of the wearable device 501. Therefore, the first time may further include a difference between a time required to process a gesture based on the motion data and a time required to process a gesture identified through the camera 425.

In an embodiment, as the movement speed of the hand 611 increases, the wearable device 401 may set a first distance to be longer. In an embodiment, as the moving speed of the hand 611 decreases, the wearable device 401 may set the first distance to be shorter. In an embodiment, the wearable device 401 may set, as the first distance, a value obtained by multiplying the movement speed of the hand 611 by the designated first time. For example, the wearable device 401 may set, as the first distance, a value obtained by multiplying relative movement speed of the hand 611 to each of obstruction objects by the designated first time. For example, the wearable device 401 may set, as the first distance, a value obtained by multiplying relative movement speed of the hand 611 with respect to each of the obstruction objects by the designated first time. In an embodiment, the wearable device 401 may set different first distances with respect to each obstruction area of the obstruction objects based on the relative movement speed of the hand 611.

In an embodiment, the wearable device 401 may set one or more areas 630 and 635 based on the first distance. In an embodiment, each of the one or more areas 630 and 635 may be an area within the first distance from each of the obstruction areas 620 and 625. In an embodiment, an area within the first distance from an obstruction area may be a wake-up area. In an embodiment, an area within the first distance from an obstruction area may be a transmission initiation area. Hereinafter, the area within the first distance from the obstruction area may be referred to as the wake-up area.

In an embodiment, the wearable device 401 may identify that the hand 611 has entered one wake-up area among the one or more wake-up areas 630 and 635. In an embodiment, the wearable device 401 may transmit a wake-up signal to the wearable device 501 worn on the hand 611 in response to identifying that the hand 611 has entered the wake-up areas 630 and 635. In an embodiment, the wearable device 501 may receive the wake-up signal through communication circuitry 590. In an embodiment, the wearable device 501 may transition from a low-power state 593 to a normal state 591 in response to receiving the wake-up signal. In an embodiment, the communication circuitry 590 of the wearable device 501 may transition from a sleep state to an active state in response to receiving the wake-up signal. In an embodiment, as the wearable device 501 transitions from the low-power state 593 to the normal state 591, the processor 520, the motion sensor 573, and the communication circuitry 590 of the wearable device 501 may transition to the active state.

In an embodiment, the wearable device 401 may request motion data from the wearable device 501. In an embodiment, the wearable device 401 may request the motion data from the wearable device 501 while the wearable device 501 operates in the normal state 591. In an embodiment, the wearable device 401 may request the motion data from the wearable device 501 while the hand 611 is located in the wake-up areas 630 and 635.

In an embodiment, the wearable device 401 may set a period (or the number of times of transmission of the motion data or a bit rate) in which the wearable device 501 transmits the motion data, based on a state of the wearable device 401 and/or a state of the wearable device 501.

In an embodiment, the wearable device 401 may set the period (or the number of times of transmission of the motion data or the bit rate) in which the wearable device 501 transmits the motion data, based on an application 146 being executed in the wearable device 401. In an embodiment, the wearable device 401 may set the period, in which the wearable device 501 transmits the motion data, to be shorter, based on the application 146 being executed being an application of a type that requires a low delay of a gesture (e.g., a game application). In an embodiment, the wearable device 401 may set the number of times, in which the wearable device 501 transmits the motion data, to be more, based on the application 146 being executed being the application of the type that requires the low delay of the gesture (e.g., the game application). In an embodiment, the wearable device 401 may further increase the bit rate for transmitting the motion data of the wearable device 501, based on the application 146 being executed being the application of the type that requires the low delay of the gesture (e.g., the game application). According to an embodiment, the wearable device 401 may provide the user 500 with information related to a change in the period (or the number of times of transmission of the motion data or the bit rate) in which the wearable device 501 transmits the motion data. For example, the wearable device 401 may display, through a display 420, the information (e.g., a pop-up menu or a notification message) related to the change in the period (or the number of times of transmission of the motion data or the bit rate) in which the wearable device 501 transmits the motion data.

In an embodiment, the wearable device 401 may set the period (or the number of times of transmission of the motion data or the bit rate) in which the wearable device 501 transmits the motion data, based on a SOC of a battery (e.g., a battery 189) of the wearable device 401. In an embodiment, as the SOC of the battery (e.g., the battery 189) of the wearable device 401 decreases, the wearable device 401 may set the period, in which the wearable device 501 transmits the motion data, to be longer. In an embodiment, as the SOC of the battery (e.g., the battery 189) of the wearable device 401 decreases, the wearable device 401 may set the number of times, in which the wearable device 501 transmits the motion data, to be less. In an embodiment, as the SOC of the battery (e.g., the battery 189) of the wearable device 401 decreases, the wearable device 401 may further decrease the bit rate for transmitting the motion data of the wearable device 501. However, the present disclosure is not limited to the above example embodiment.

In an embodiment, the wearable device 401 may set the period (or the number of times of transmission of the motion data or the bit rate) in which the wearable device 501 transmits the motion data, based on a SOC of a battery 580 of the wearable device 501. In an embodiment, as the SOC of the battery 580 of the wearable device 501 decreases, the wearable device 401 may set the period, in which the wearable device 501 transmits the motion data, to be longer. In an embodiment, as the SOC of the battery 580 of the wearable device 501 decreases, the wearable device 401 may set the number of times, in which the wearable device 501 transmits the motion data, to be less. In an embodiment, as the SOC of the battery 580 of the wearable device 501 decreases, the wearable device 401 may further decrease the bit rate for transmitting the motion data of the wearable device 501. However, the present disclosure is not limited to the above example embodiment.

In an embodiment, the wearable device 401 may identify a gesture based on one or more consecutive movements of the hand 611 identified through the camera 425. In an embodiment, the wearable device 401 may identify the gesture based on the one or more consecutive movements of the hand 611 while the wearable device 501 operates in the normal state 591. In an embodiment, the wearable device 401 may identify the gesture based on the one or more consecutive movements of the hand 611 while the hand 611 is located in the wake-up areas 630 and 635. Hereinafter, the gesture (or a pose) of the hand 611 identified through the camera 425 may be referred to as a first gesture.

In an embodiment, the wearable device 401 may identify a gesture (or a pose) of the wearable device 501 based on motion data from the wearable device 501. In an embodiment, the wearable device 401 may identify motions of the wearable device 501 based on the motion data. In an embodiment, the wearable device 401 may identify the gesture (or the pose) of the wearable device 501 based on the motions of the wearable device 501. In an embodiment, the wearable device 401 may identify the gesture based on motion data obtained while the wearable device 501 operates in the normal state 591. In an embodiment, the wearable device 401 may identify the gesture based on motion data obtained while the hand 611 is located in the wake-up areas 630 and 635. Hereinafter, the gesture (or the pose) of the hand 611 identified through the camera 425 may be referred to as the first gesture. Hereinafter, the gesture (or the pose) of the wearable device 501 identified based on the motion data may be referred to as a second gesture.

In an embodiment, the wearable device 401 may perform a set function with respect to a user input based on the first gesture and/or the second gesture. In an embodiment, the wearable device 401 may perform the set function with respect to the user input based on the first gesture and/or the second gesture obtained while the wearable device 501 operates in the normal state 591. In an embodiment, the wearable device 401 may perform the set function with respect to the user input based on the first gesture and/or the second gesture obtained while the hand 611 is located in the wake-up areas 630 and 635. In an embodiment, in a case where the first gesture is not identified as the hand 611 moves out of the FOV 600, the wearable device 401 may perform a set function with respect to a user input based on the second gesture. In an embodiment, in a case where the first gesture is identified as the hand 611 is identified in the FOV 600 in the wake-up areas 630 and 635, the wearable device 401 may perform the set function with respect to the user input based on the first gesture and the second gesture. For example, the set function may include a control related to content being played (e.g., playback, stopping, or volume control), a control for the application 146, or a control for a remote electronic device (e.g., an electronic device 108). In an embodiment, the control for the application 146 may include a control related to an application (e.g., capturing, preview zoom-in, preview zoom-out, or blood pressure measurement), and/or execution of an application (e.g., calling a voice recognition function, execution of a camera application, or execution of a health application). In an embodiment, the control of the remote electronic device (e.g., the electronic device 108) may include unlocking a door (e.g., a door of a vehicle or a front door of a house) related to the remote electronic device (e.g., the electronic device 108) or locking the door. In an embodiment, the control for the remote electronic device (e.g., the electronic device 108) may include a control of a function (e.g., navigation, air conditioner, infotainment, noise canceling, or external sound listening) related to the remote electronic device (e.g., the electronic device 108). However, the present disclosure is not limited to the above example embodiment.

In an embodiment, the wearable device 401 may identify that the hand 611 moves out of the wake-up areas 630 and 635. In an embodiment, the wearable device 401 may transmit a sleep signal to the wearable device 501 worn on the hand 611 in response to identifying that the hand 611 moves out of the wake-up areas 630 and 635 in which the hand 611 is located. In an embodiment, the wearable device 501 may receive the sleep signal through the communication circuitry 590. In an embodiment, the wearable device 501 may transition from the normal state 591 to the low-power state 593 in response to receiving the sleep signal. In an embodiment, the communication circuitry 590 of the wearable device 501 may transition from the active state to the sleep state in response to receiving the sleep signal. In an embodiment, as the wearable device 501 transitions from the normal state 591 to the low-power state 593, at least a part of the processor 520, the motion sensor 573, or the communication circuitry 590 of the wearable device 501 may transition to an inactive state.

As described above, the wearable device 401 may transition the wearable device 501 to the low-power state to reduce power consumption of the wearable device 501 while the hand 611 is identified in the FOV 600 of the camera 425. In addition, the wearable device 401 may identify a gesture input of the user 500 by receiving the motion data from the wearable device 501 while the hand 611 is not identified in the FOV 600 of the camera 425. Accordingly, the wearable device 401 may reduce power consumption of the wearable device 501 while also increasing reliability of a gesture input of the user 500 with respect to the wearable device 401.

FIG. 6C illustrates an example of a situation in which a user wearing a wearable device moves a hand in an embodiment.

A wearable device 401 of FIG. 6C may correspond to the electronic device 101 of FIG. 1. The wearable device 401 of FIG. 6C may correspond to the wearable device 200 of FIGS. 2A and 2B. The wearable device 401 of FIG. 6C may correspond to the wearable device 300 of FIGS. 3A and 3B. The wearable device 401 of FIG. 6C may correspond to the wearable device 401 of FIG. 4. A wearable device 501 of FIG. 6C may correspond to the wearable device 501 of FIG. 5A, 5B, and 5C. FIG. 6C may be described with reference to FIGS. 1, 2A, 2B, 3A, 3B, 4, 5A, 5B, 5C, and 5D.

Compared with FIG. 6A, FIG. 6C may illustrate a FOV 600 of a camera 425 from three dimensions to two dimensions.

In an embodiment, the wearable device 401 may be in a state of not being communicatively connected with the wearable device 501. In an embodiment, the wearable device 401 may be in a state in which the communication connection with the wearable device 501 has not been established based on a result of object recognition and/or scene understanding. For example, the wearable device 401 may command the wearable device 501 to operate in an ultra-low-power state 595, based on the number of objects obstructing identification of a hand 611 in the FOV 600 or a probability of the obstruction. For example, the wearable device 401 may command the wearable device 501 to operate in the ultra-low-power state 595, based on the number of objects obstructing the identification of the hand 611 in the FOV 600 less than a designated number or the probability of the obstruction less than a designated probability. In an embodiment, the probability of the obstruction may be determined based on an artificial intelligence model trained to calculate a probability of the obstruction based on a type of object. However, the present disclosure is not limited to the above example embodiment. In an embodiment, the probability of the obstruction may be determined based on the artificial intelligence model trained to calculate the probability of the obstruction based on a distance between an object and the hand 611 and/or a disposition of the object within the FOV 600.

In an embodiment, the wearable device 401 may be in the state in which the communication connection with the wearable device 501 has not been established based on a type of an application 146 being executed. For example, the wearable device 401 may command the wearable device 501 to operate in the ultra-low-power state 595 based on the application 146 being executed being an application of a different type (e.g., a content playback application) from an application of a type that requires a gesture input (e.g., a game application).

In an embodiment, the wearable device 501 may transition from a low-power state 593 to the ultra-low-power state 595. In an embodiment, the wearable device 401 may be in the state in which the communication connection with the wearable device 501 has not been established based on a SOC (SOC) of a battery 580 of the wearable device 501. For example, the wearable device 401 may transition from the low-power state 593 to the ultra-low-power state 595 based on the SOC of the battery 580 of the wearable device 501 less than a designated first SOC (e.g., 60%) and greater than or equal to a second SOC (e.g., 30%).

In an embodiment, the wearable device 401 may be in a state (or in an unpaired state) in which the communication connection with the wearable device 501 has not been established. In an embodiment, the wearable device 501 may be operating in the ultra-low-power state 595.

Referring to FIG. 6C, the wearable device 401 may obtain, through the camera 425, an image with respect to the FOV 600 of the camera 425. In an embodiment, the wearable device 401 may perform object recognition and/or scene understanding based on the image obtained through the camera 425. In an embodiment, the wearable device 401 may identify one or more objects 501, 611, and 620 within the FOV 600 of the camera 425 based on object recognition and/or scene understanding.

In an embodiment, the wearable device 401 may identify one or more obstruction areas 620 and 630. In an embodiment, the obstruction areas 620 and 625 may be areas in which the hand 611 (or a finger) is not identified through the FOV 600 of the camera 425. For example, the obstruction area 620 may be an area of an obstruction object (e.g., a desk), among objects within the FOV 600, that may occlude the hand 611 (or the finger) according to a movement of the hand 611 (or the finger). For example, the obstruction area 625 may be an area outside the FOV 600. Herein, the obstruction object (e.g., the desk) occluding the hand 611 (or the finger) may mean that the obstruction object (e.g., the desk) is located between the hand 611 (or the finger) and the camera 425.

In an embodiment, the wearable device 401 may identify a movement (or a movement trajectory) of the hand 611. In an embodiment, the wearable device 401 may identify a movement of the hand 611 within the FOV 600 of the camera 425. In an embodiment, the wearable device 401 may identify a relative movement of the hand 611. Herein, the relative movement may include a direct movement of the hand 611, a movement of the hand 611 relative to the FOV 600 according to a movement of the wearable device 401, and/or a movement of the hand 611 relative to an object according to a movement of the object within the FOV 600. Hereinafter, the movement of the hand 611 and the relative movement of the hand 611 may be referred to as a movement of the hand 611.

In an embodiment, the wearable device 401 may identify (or set) distances based on a movement of the hand 611. In an embodiment, the wearable device 401 may identify distances from the obstruction areas 620 and 625 based on a movement of the hand 611. In an embodiment, the wearable device 401 may identify a first distance reachable by the hand 611 within a designated first time in the obstruction areas 620 and 625 according to a movement of the hand 611. In an embodiment, the wearable device 401 may identify a second distance reachable by the hand 611 within a designated second time in the obstruction areas 620 and 625 according to a movement of the hand 611. In an embodiment, the second distance may be longer than the first distance. In an embodiment, the first time may be determined based on a processing delay time. In an embodiment, the first time may be determined based on a time required for the wearable device 501 to transmit motion data to the wearable device 401. For example, the first time may include a delay time by a network and a delay time for processing the motion data. For example, the first time may be greater than or equal to a time including the delay time by the network and the delay time for processing the motion data. In an embodiment, the second time may be determined to be longer than the first time. In an embodiment, the second time may be determined based on a time that is a sum of the first time and a time required for pairing between the wearable device 401 and the wearable device 501.

In an embodiment, as movement speed of the hand 611 increases, the wearable device 401 may set the first distance and the second distance to be longer. In an embodiment, as the moving speed of the hand 611 decreases, the wearable device 401 may set the first distance and the second distance to be shorter. In an embodiment, the wearable device 401 may set, as the first distance, a value obtained by multiplying the movement speed of the hand 611 by the designated first time. In an embodiment, the wearable device 401 may set, as the second distance, a value obtained by multiplying the movement speed of the hand 611 by the designated second time. For example, the wearable device 401 may set, as the first distance, a value obtained by multiplying relative movement speed of the hand 611 to each of obstruction objects by the designated first time. For example, the wearable device 401 may set, as the second distance, a value obtained by multiplying relative movement speed of the hand 611 to each of obstruction objects by the designated second time. For example, the wearable device 401 may set, as the first distance, a value obtained by multiplying relative movement speed of the hand 611 with respect to each of the obstruction objects by the designated first time. For example, the wearable device 401 may set, as the second distance, a value obtained by multiplying relative movement speed of the hand 611 with respect to each of the obstruction objects by the designated second time. In an embodiment, the wearable device 401 may set different first distances with respect to each obstruction area of the obstruction objects based on the relative movement speed of the hand 611. In an embodiment, the wearable device 401 may set different second distances with respect to each obstruction area of the obstruction objects based on the relative movement speed of the hand 611.

In an embodiment, the wearable device 401 may set one or more areas 630 and 635 based on the first distance. In an embodiment, each of the one or more areas 630 and 635 may be an area within the first distance from each of the obstruction areas 620 and 625. In an embodiment, an area within the first distance from an obstruction area may be a wake-up area. In an embodiment, an area within the first distance from an obstruction area may be a transmission initiation area. Hereinafter, the area within the first distance from the obstruction area may be referred to as the wake-up area

In an embodiment, the wearable device 401 may set one or more areas 640 and 645 based on the second distance. In an embodiment, each of the one or more areas 640 and 645 may be an area within the second distance from each of the obstruction areas 620 and 625. In an embodiment, an area within the second distance from an obstruction area may be a pairing area. In an embodiment, an area within the second distance from an obstruction area may be a communication connection area. Hereinafter, the area within the second distance from the obstruction area may be referred to as the pairing area.

In an embodiment, the wearable device 401 may identify that the hand 611 has entered one area among the one or more pairing areas 640 and 645. In an embodiment, the wearable device 401 may transmit a connection request signal to the wearable device 501 worn on the hand 611 in response to identifying that the hand 611 has entered the pairing areas 640 and 645. In an embodiment, the wearable device 501 may receive the connection request signal through communication circuitry 590. In an embodiment, the wearable device 501 may transition from the ultra-low-power state 595 to the low-power state 593 in response to receiving the connection request signal. In an embodiment, the communication circuitry 590 of the wearable device 501 may transition from a standby state to a sleep state in response to receiving the connection request signal.

In an embodiment, the wearable device 401 may identify that the hand 611 has entered one wake-up area among the one or more wake-up areas 630 and 635. In an embodiment, the wearable device 401 may identify that the hand 611 has entered the wake-up areas 630 and 635 while the wearable device 501 operates in the low-power state 593. In an embodiment, the wearable device 401 may identify that the hand 611 has entered the wake-up areas 630 and 635 from the pairing areas 640 and 645.

In an embodiment, the wearable device 401 may transmit a wake-up signal to the wearable device 501 worn on the hand 611 in response to identifying that the hand 611 has entered the wake-up areas 630 and 635. In an embodiment, the wearable device 501 may receive the wake-up signal through communication circuitry 590. In an embodiment, the wearable device 501 may transition from a low-power state 593 to a normal state 591 in response to receiving the wake-up signal. In an embodiment, the communication circuitry 590 of the wearable device 501 may transition from a sleep state to an active state in response to receiving the wake-up signal. In an embodiment, as the wearable device 501 transitions from the low-power state 593 to the normal state 591, the processor 520, the motion sensor 573, and the communication circuitry 590 of the wearable device 501 may transition to the active state.

In an embodiment, the wearable device 401 may request motion data from the wearable device 501. In an embodiment, the wearable device 401 may request the motion data from the wearable device 501 while the wearable device 501 operates in the normal state 591. In an embodiment, the wearable device 401 may request the motion data from the wearable device 501 while the hand 611 is located in the wake-up areas 630 and 635.

In an embodiment, the wearable device 401 may set a period (or the number of times of transmission of the motion data or a bit rate) in which the wearable device 501 transmits the motion data, based on a state of the wearable device 401 and/or a state of the wearable device 501. For example, the wearable device 401 may set the period (or the number of times of transmission of the motion data or the bit rate) in which the wearable device 501 transmits the motion data, based on a type of the application 146 being executed in the wearable device 401, a SOC of a battery (e.g., a battery 189) of the wearable device 401, and/or a SOC of a battery 580 of the wearable device 501.

In an embodiment, the wearable device 401 may identify a gesture based on one or more consecutive movements of the hand 611 identified through the camera 425. In an embodiment, the wearable device 401 may identify the gesture based on the one or more consecutive movements of the hand 611 while the wearable device 501 operates in the normal state 591. In an embodiment, the wearable device 401 may identify the gesture based on the one or more consecutive movements of the hand 611 while the hand 611 is located in the wake-up areas 630 and 635. Hereinafter, the gesture (or a pose) of the hand 611 identified through the camera 425 may be referred to as a first gesture.

In an embodiment, the wearable device 401 may identify a gesture (or a pose) of the wearable device 501 based on motion data from the wearable device 501. In an embodiment, the wearable device 401 may identify motions of the wearable device 501 based on the motion data. In an embodiment, the wearable device 401 may identify the gesture (or the pose) of the wearable device 501 based on the motions of the wearable device 501. In an embodiment, the wearable device 401 may identify the gesture based on motion data obtained while the wearable device 501 operates in the normal state 591. In an embodiment, the wearable device 401 may identify the gesture based on motion data obtained while the hand 611 is located in the wake-up areas 630 and 635. Hereinafter, the gesture (or the pose) of the hand 611 identified through the camera 425 may be referred to as the first gesture. Hereinafter, the gesture (or the pose) of the wearable device 501 identified based on the motion data may be referred to as a second gesture.

In an embodiment, the wearable device 401 may perform a set function with respect to a user input based on the first gesture and/or the second gesture. In an embodiment, the wearable device 401 may perform the set function with respect to the user input based on the first gesture and/or the second gesture obtained while the wearable device 501 operates in the normal state 591. In an embodiment, the wearable device 401 may perform the set function with respect to the user input based on the first gesture and/or the second gesture obtained while the hand 611 is located in the wake-up areas 630 and 635. In an embodiment, in a case where the first gesture is not identified as the hand 611 moves out of the FOV 600, the wearable device 401 may perform a set function with respect to a user input based on the second gesture. In an embodiment, in a case where the first gesture is identified as the hand 611 is identified in the FOV 600 in the wake-up areas 630 and 635, the wearable device 401 may perform the set function with respect to the user input based on the first gesture and the second gesture. For example, the set function may include a control related to content being played (e.g., playback, stopping, or volume control), a control for the application 146, or a control for a remote electronic device (e.g., an electronic device 108). In an embodiment, the control for the application 146 may include a control related to an application (e.g., capturing, preview zoom-in, preview zoom-out, or blood pressure measurement), and/or execution of an application (e.g., calling a voice recognition function, execution of a camera application, or execution of a health application). In an embodiment, the control of the remote electronic device (e.g., the electronic device 108) may include unlocking a door (e.g., a door of a vehicle or a front door of a house) related to the remote electronic device (e.g., the electronic device 108) or locking the door. In an embodiment, the control for the remote electronic device (e.g., the electronic device 108) may include a control of a function (e.g., navigation, air conditioner, infotainment, noise canceling, or external sound listening) related to the remote electronic device (e.g., the electronic device 108). However, the present disclosure is not limited to the above example embodiment.

In an embodiment, the wearable device 401 may identify that the hand 611 moves out of the wake-up areas 630 and 635. In an embodiment, the wearable device 401 may transmit a sleep signal to the wearable device 501 worn on the hand 611 in response to identifying that the hand 611 moves out of the wake-up areas 630 and 635 in which the hand 611 is located. In an embodiment, the wearable device 501 may receive the sleep signal through the communication circuitry 590. In an embodiment, the wearable device 501 may transition from the normal state 591 to the low-power state 593 in response to receiving the sleep signal. In an embodiment, the communication circuitry 590 of the wearable device 501 may transition from the active state to the sleep state in response to receiving the sleep signal. In an embodiment, as the wearable device 501 transitions from the normal state 591 to the low-power state 593, at least a part of the processor 520, the motion sensor 573, or the communication circuitry 590 of the wearable device 501 may transition to an inactive state.

In an embodiment, the wearable device 401 may identify that the hand 611 moves out of the pairing areas 640 and 645. In an embodiment, the wearable device 401 may transmit a connection termination signal to the wearable device 501 worn on the hand 611 in response to identifying that the hand 611 moves out of the pairing areas 640 and 645 in which the hand 611 is located. In an embodiment, the wearable device 501 may receive the connection termination signal through the communication circuitry 590. In an embodiment, the wearable device 501 may transition from the low-power state 593 to the ultra-low-power state 595 in response to receiving the connection termination signal. In an embodiment, the communication circuitry 590 of the wearable device 501 may transition from the sleep state to the standby state in response to receiving the connection termination signal in the low-power state 593.

As described above, the wearable device 401 may transition the wearable device 501 to a standby state to further reduce power consumption of the wearable device 501 while the hand 611 is identified in the FOV 600 of the camera 425. In addition, the wearable device 401 may set an area for transitioning the wearable device 401 from the standby state to a sleep state and an area for transitioning from the sleep state to the normal state in consideration of a situation in which the hand 611 may not be identified in the FOV 600 of the camera 425. Accordingly, the wearable device 401 may further reduce power consumption of the wearable device 501 while also increasing reliability of a gesture input of the user 500 with respect to the wearable device 401.

In FIGS. 6A and 6B, it is exemplified that the wearable device 401 sets the first distance and/or the second distance for receiving the motion data with respect to the wearable device 501 in a case where the user 500 wears the wearable device 501 through the hand 611. However, this is merely an example. According to an embodiment, the user 500 wearing the wearable device 401 and a user wearing the wearable device 501 may be different from each other.

In an embodiment, the wearable device 401 may identify a movement of a gaze 505 of another user through the camera 425. In an embodiment, the wearable device 401 may identify a gesture based on the movement of the gaze 505 of the other user through the camera 425. In an embodiment, the wearable device 401 may set a first distance and/or a second distance to obtain motion data from the wearable device 501 worn by the other user. In an embodiment, the wearable device 401 may perform a communication connection with the wearable device 501 based on the wearable device 501 worn by the other user being located within the second distance. In an embodiment, the wearable device 401 may request the motion data from the wearable device 501 based on the wearable device 501 worn by the other user being located within the first distance. In an embodiment, the wearable device 401 may identify a gesture of the wearable device 401 based on the motion data from the wearable device 501 worn by the other user.

As described above, the wearable device 401 may identify a gesture of the other user and/or a gesture of the wearable device 501 worn by the other user. Accordingly, the wearable device 401 may enable a plurality of users to simultaneously perform a specific action by obtaining one or more gestures from different users (e.g., the user 500 and the other user). For example, the wearable device 401 may enable simultaneous performance of specific actions such as a joint presentation or a collaborative performance, by obtaining one or more gestures from different users (e.g., the user 500 and the other user).

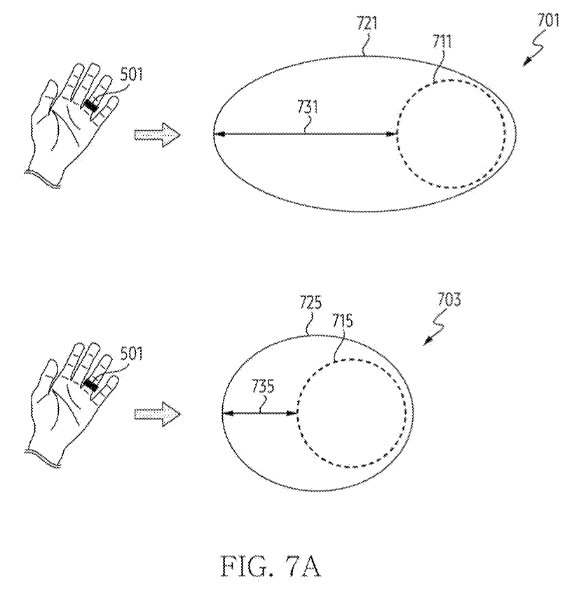

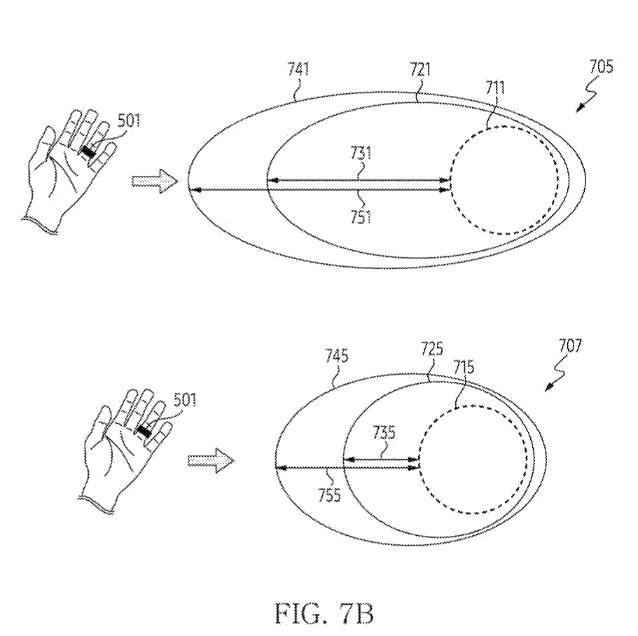

FIG. 7A illustrates an example of situations in which a wearable device sets a distance in an embodiment.

A wearable device 501 of FIG. 7A may correspond to the wearable device 501 of FIGS. 5A, 5B, and 5C. FIG. 7A may be described with reference to FIGS. 1, 2A, 2B, 3A, 3B, 4, 5A, 5B, 5C, 5D, 6A, and 6B

Situations 701 and 703 of FIG. 7A may illustrate an example in which a wearable device 401 sets only one area (or a wake-up area 721 or 725) based on a SOC of a battery 580 of the wearable device 501. In an embodiment, the wearable device 401 may instruct the wearable device 501 to operate in a low-power state 593 based on the SOC (e.g., 60%) of the battery 580 of the wearable device 501 being greater than or equal to a first SOC (e.g., 60%). In an embodiment, as the wearable device 501 operates in the low-power state 593, the wearable device 401 may set only one area (e.g., a wake-up area) among at least two areas (e.g., the wake-up area and a pairing area) related to obtaining motion data from the wearable device 501.

In an embodiment, the wearable device 401 may identify (or set) first distances 731 and 735 for setting the wake-up areas 721 and 725 based on a movement of a hand 611. In an embodiment, the wearable device 401 may identify the first distances 731 and 735 from obstruction areas 711 and 715 based on a movement of the hand 611. In an embodiment, the wearable device 401 may identify the first distances 731 and 735 reachable by the hand 611 within a designated first time in the obstruction areas 711 and 715 according to the movement of the hand 611. In an embodiment, the first time may be determined based on a processing delay time. In an embodiment, the first time may be determined based on a time required for the wearable device 501 to transmit motion data to the wearable device 401. For example, the first time may include a delay time by a network between the wearable device 401 and the wearable device 501. For example, the first time may include a delay time for processing motion data of the wearable device 401 and/or the wearable device 501. For example, the first time may include the delay time by the network and the delay time for processing the motion data.

In an embodiment, as movement speed of the hand 611 increases, the wearable device 401 may set the first distances 731 and 735 to be longer. In an embodiment, as the moving speed of the hand 611 decreases, the wearable device 401 may set the first distances 731 and 735 to be shorter. Referring to FIG. 7A, the first distance 731 in the situation 701 where the speed is faster may be longer than the first distance 735 in the situation 703 where the speed is slower.

In an embodiment, the wearable device 401 may set the one or more wake-up areas 721 and 725 based on the first distances 731 and 735. In an embodiment, each of the one or more wake-up areas 721 and 725 may be an area within the first distance 731 and 735 from each of the obstruction areas 711 and 715. In FIG. 7A, the wake-up areas 721 and 725 are illustrated as having an elliptical shape, but this is merely an example. According to an embodiment, the wake-up areas 721 and 725 may have various shapes. For example, for each of the wake-up areas 721 and 725, a shape of each of the wake-up areas 721 and 725 may be determined by at least one of a movement of a FOV 600 of a camera 425 (e.g., a movement of the FOV 600 according to a movement of a head of a user 500), a relative distance or movement between the hand 611 and an obstruction object, a shape of the obstruction object, or the first time. For example, each of the wake-up areas 721 and 725 may have a shape that includes the obstruction object in the first distance 731 or 735. For example, each of the wake-up areas 721 and 725 may be set by weights based on a characteristic of the obstruction object (e.g., a probability of obstruction, a probability of inputting a gesture, or an additional obstruction area). Herein, the probability of the obstruction of the obstruction object may be a probability calculated based on a type of the obstruction object. The probability of inputting a gesture may be a probability of inputting a gesture when the hand of the user 500 is occluded by the obstruction object. The additional obstruction area may be set as an area in which a possibility of being occluded by the obstruction object (e.g., a desk) exists (e.g., an area within a designated distance from a boundary of an edge of the desk).

FIG. 7B illustrates an example of situations in which a wearable device sets distances in an embodiment.

A wearable device 501 of FIG. 7B may correspond to the wearable device 501 of FIGS. 5A, 5B, and 5C. FIG. 7B may be described with reference to FIGS. 1, 2A, 2B, 3A, 3B, 4, 5A, 5B, 5C, 5D, 6A, 6B, and 6C.

Situations 705 and 707 of FIG. 7B may represent an example in which a wearable device 401 sets two areas (or wake-up areas 721 and 725 and pairing areas 741 and 745) based on a SOC of a battery 580 of the wearable device 501. In an embodiment, the wearable device 401 may instruct the wearable device 501 to operate in an ultra-low-power state 595, based on the SOC of the battery 580 of the wearable device 501 being less than a designated first SOC (e.g., 60%) and greater than or equal to a second SOC (e.g., 30%). In an embodiment, as the wearable device 501 operates in the ultra-low-power state 595, the wearable device 401 may set at least two areas (e.g., the wake-up areas 721 and 725 and the pairing areas 741 and 745) related to obtaining motion data from the wearable device 501.

In an embodiment, the wearable device 401 may identify (or set) first distances 731 and 735 for setting the wake-up areas 721 and 725 and second distances 751 and 755 for setting the pairing areas 741 and 745, based on a movement of a hand 611. In an embodiment, the wearable device 401 may identify the first distances 731 and 735 and the second distances 751 and 755 from obstruction areas 711 and 715, based on the movement of the hand 611. In an embodiment, the wearable device 401 may identify the first distances 731 and 735 reachable by the hand 611 within a designated first time in the obstruction areas 711 and 715 according to the movement of the hand 611. In an embodiment, the wearable device 401 may identify the second distances 751 and 755 reachable by the hand 611 within a designated second time in the obstruction areas 711 and 715 according to the movement of the hand 611.

In an embodiment, the second distances 751 and 755 may be longer than the first distances 731 and 735. In an embodiment, the first time may be determined based on a processing delay time. In an embodiment, the first time may be determined based on a time required for the wearable device 501 to transmit motion data to the wearable device 401. For example, the first time may include a delay time by a network and a delay time for processing motion data. In an embodiment, the second time may be determined to be longer than the first time. In an embodiment, the second time may be determined based on a time that is a sum of the first time and a time required for pairing between the wearable device 401 and the wearable device 501.

In an embodiment, as movement speed of the hand 611 increases, the wearable device 401 may set the first distances 731 and 735 and the second distances 751 and 755 to be longer. In an embodiment, as the moving speed of the hand 611 decreases, the wearable device 401 may set the first distances 731 and 735 and the second distances 751 and 755 to be shorter. Referring to FIG. 7B, the first distance 731 and the second distance 751 in the situation 705 where the speed is faster may be longer than the first distance 735 and the second distance 755 in the situation 707 where the speed is slower.

In an embodiment, the wearable device 401 may set the one or more wake-up areas 721 and 725 based on the first distances 731 and 735. In an embodiment, each of the one or more wake-up areas 721 and 725 may be an area within the first distance 731 and 735 from each of the obstruction areas 711 and 715. In an embodiment, the wearable device 401 may set the one or more pairing areas 741 and 745 based on the second distances 751 and 755. In an embodiment, each of the one or more pairing areas 741 and 745 may be an area within the second distances 751 and 755 from each of the obstruction areas 711 and 715. In FIG. 7B, the wake-up areas 721 and 725 and the pairing areas 741 and 745 are illustrated as having an elliptical shape, but this is merely an example. According to an embodiment, the wake-up areas 721 and 725 and the pairing areas 741 and 745 may have various shapes. For example, for each of the wake-up areas 721 and 725 and the pairing areas 741 and 745, a shape of each of the wake-up areas 721 and 725 and the pairing areas 741 and 745 may be determined by at least one of a movement of a FOV 600 of a camera 425 (e.g., a movement of the FOV 600 according to a movement of a head of a user 500), a relative distance or movement between the hand 611 and an obstruction object, a shape of the obstruction object, the first time, or the second time. For example, each of the wake-up areas 721 and 725 may have a shape that includes the obstruction object in the first distance. For example, each of the pairing areas 741 and 745 may have a shape that includes the obstruction object in the second distance. For example, each of the pairing areas 741 and 745 may be set by weights based on a characteristic of the obstruction object (e.g., a probability of obstruction, a probability of inputting a gesture, or an additional obstruction area). Herein, the probability of the obstruction of the obstruction object may be a probability calculated based on a type of the obstruction object. The probability of inputting a gesture may be a probability of inputting a gesture when the hand of the user 500 is occluded by the obstruction object. The additional obstruction area may be set as an area in which a possibility of being occluded by the obstruction object (e.g., a desk) exists (e.g., an area within a designated distance from a boundary of an edge of the desk).

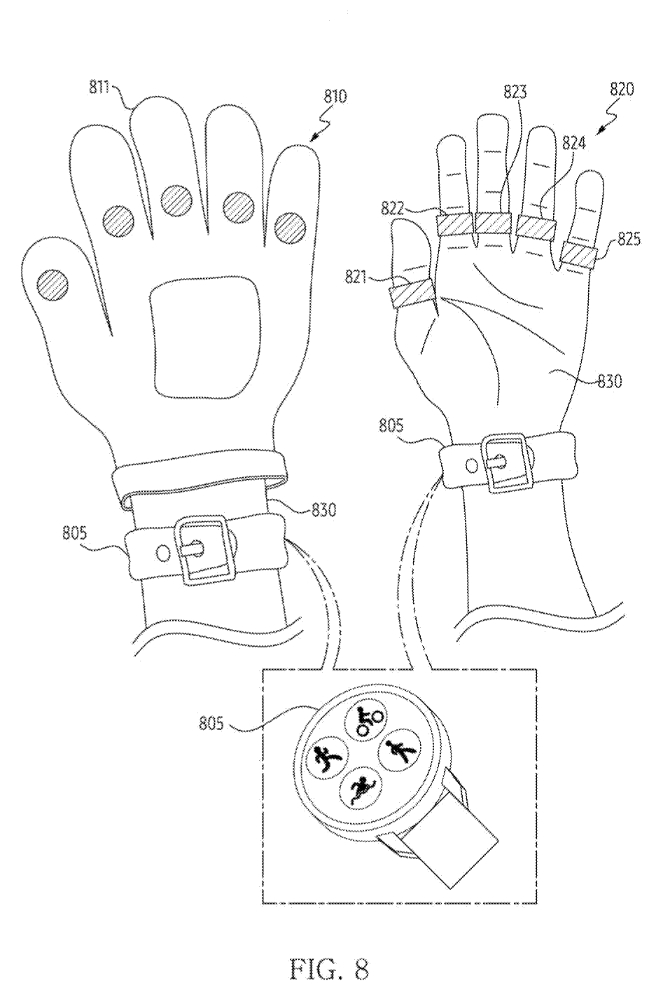

FIG. 8 illustrates an example of a situation in which a user wears a plurality of wearable devices.

Wearable devices (e.g., 805, 811, 821, 822, 823, 824, and 825) of FIG. 8 may correspond to the wearable device 501 of FIGS. 5A, 5B, and 5C. FIG. 8 may be described with reference to FIGS. 1, 2A, 2B, 3A, 3B, 4, 5A, 5B, 5C, 5D, 6A, 6B, and 6C.

In an embodiment, a wearable device 401 may identify one or more objects 805, 811, 821, 822, 823, 824, 825, and 830 within a FOV 600 of a camera 425. In an embodiment, the wearable device 401 may identify the one or more objects 805, 811, 821, 822, 823, 824, 825, and 830 within the FOV 600 of the camera 425 based on object recognition and/or scene understanding. In an embodiment, among the one or more objects 805, 811, 821, 822, 823, 824, 825, and 830, some objects 805, 811, 821, 822, 823, 824, and 825 may be wearable devices. In an embodiment, the one or more objects 805, 811, 821, 822, 823, 824, 825, and 830 may include a hand 830 of a user 500. In an embodiment, the hand 830 may be a hand of a user 500 wearing a wearable device (e.g., 805, 811, 821, 822, 823, 824, and 825). However, the present disclosure is not limited to the above example embodiment.

Referring to a situation 810 of FIG. 8, the user 500 may wear a glove-type wearable device (e.g., 811) and a watch-type wearable device (e.g., 805). In an embodiment, in the glove-type wearable device (e.g., 811), a motion sensor may be attached to each of fingers of the hand 830 of the user 500. In an embodiment, the glove-type wearable device (e.g., 811) may obtain motion data of each of the fingers of the hand 830 of the user 500. In an embodiment, the watch-type wearable device (e.g., 805) may obtain motion data of a wrist.

Referring to a situation 820 of FIG. 8, the user 500 may wear two or more ring-type wearable devices (e.g., 821, 822, 823, 824, and 825) and the watch-type wearable device (e.g., 805). In an embodiment, the two or more ring- type wearable devices (e.g., 821, 822, 823, 824, and 825) may be worn on each of the fingers of the hand 830 of the user 500. In an embodiment, each of the two or more ring-type wearable devices (e.g., 821, 822, 823, 824, and 825) may obtain motion data of a worn finger among the fingers of the hand 830 of the user 500.

In an embodiment, the wearable device 401 may identify that two or more wearable devices (e.g., 805, 811, 821, 822, 823, 824, and 825) are worn on the hand 830 of the user 500. In an embodiment, the wearable device 401 may identify a wearable device to transmit a signal (e.g., a wake-up signal and/or a connection request signal) in a wake-up area and/or a pairing area, based on identifying that the two or more wearable devices (e.g., 805, 811, 821, 822, 823, 824, and 825) are worn on the hand 830 of the user 500.

In an embodiment, the wearable device 401 may transmit the signal (e.g., the wake-up signal and/or the connection request signal) in the wake-up area and/or the pairing area to a wearable device with the highest SOC of a battery among the two or more wearable devices (e.g., 805, 811, 821, 821, 822, 823, 824, and 825) worn on the hand 830 of the user 500. However, the present disclosure is not limited to the above example embodiment. In an embodiment, the wearable device 401 may transmit the signal (e.g., the wake-up signal and/or the connection request signal) in the wake-up area and/or the pairing area to a wearable device with the largest charging capacity of a battery among the two or more wearable devices (e.g., 805, 811, 821, 821, 822, 823, 824, and 825) worn on the hand 830 of the user 500.

In an embodiment, the wearable device 401 may transmit the signal (e.g., the wake-up signal and/or the connection request signal) in the wake-up area and/or the pairing area to a designated type of a wearable device among the two or more wearable devices (e.g., 805, 811, 821, 821, 822, 823, 824, and 825) worn on the hand 830 of the user 500. For example, in a case where an input through the hand 830 of the user 500 is a gesture using a plurality of fingers, the wearable device 401 may transmit the signal (e.g., the wake-up signal and/or the connection request signal) in the wake-up area and/or the pairing area to a wearable device (e.g., 811, 821, 822, 823, 824, or 825) worn on a finger among the two or more worn wearable devices (e.g., 805, 811, 821, 821, 822, 823, 824, and 825).

In an embodiment, the wearable device 401 may transmit the signal (e.g., the wake-up signal and/or the connection request signal) in the wake-up area and/or the pairing area to a wearable device (e.g., 811, 821, 822, 823, 824, or 825) worn on a finger requiring a movement for a gesture through the hand 830 of the user 500. In an embodiment, the wearable device 401 may change a ring-type wearable device that transmits the signal (e.g., the wake-up signal and/or the connection request signal) in the wake-up area and/or the pairing area among the two or more ring-type wearable devices (e.g., 821, 822, 823, 824, and 825), according to a position of the finger requiring the movement for the gesture through the hand 830 of the user 500. For example, in a case where a pointing gesture is performed through the hand 830 of the user 500, the wearable device 401 may transmit the signal (e.g., the wake-up signal and/or the connection request signal) in the wake-up area and/or the pairing area to a wearable device (e.g., 822) worn on an index finger among the two or more ring-type wearable devices (e.g., 821, 822, 823, 824, and 825). For example, in a case where typing is performed through the fingers of the hand 830 of the user 500, the wearable device 401 may transmit the signal (e.g., the wake-up signal and/or the connection request signal) in the wake-up area and/or the pairing area to the two or more ring-type wearable devices (e.g., 821, 822, 823, 824, and 825) other than the watch-type wearable device (e.g., 805). For example, in a case where a finger snap gesture is performed through a thumb and a middle finger of the hand 830 of the user 500, the wearable device 401 may transmit the signal (e.g., the wake-up signal and/or the connection request signal) in the wake-up area and/or the pairing area to the wearable devices (e.g., 821, and 823) among the two or more ring-type wearable devices (e.g., 821, 822, 823, 824, and 825).

According to an embodiment, the wearable device 401 may determine a wearable device to transmit the signal (e.g., the wake-up signal and/or the connection request signal) in the wake-up area and/or the pairing area, according to which ring-type wearable devices (e.g., 821, 822, 823, 824, and 825) are worn on which finger of the user 500. For example, through an artificial intelligence model for determining a wearable device to transmit the signal (e.g., the wake-up signal and/or the connection request signal) in the wake-up area and/or the pairing area according to a time, a hand of a finger on which a wearable device is worn, a position of a finger on which a wearable device is worn, and/or a type of a wearable device worn on a finger, the wearable device 401 may determine a wearable device to transmit the signal (e.g., the wake-up signal and/or the connection request signal) in the wake-up area and/or the pairing area among the ring-type wearable devices (e.g., 821, 822, 823, 824, and 825). However, the present disclosure is not limited to the above example embodiment.

In an embodiment, the wearable device 401 may set different wake-up areas and/or pairing areas according to a type of the wearable devices (e.g., 805, 811, 821, 822,823, 824, and 825) worn by the user 500. In an embodiment, the wearable device 401 may determine the wake-up area based on a time required for the wearable devices (e.g., 805, 811, 821, 822, 823, 824, and 825) to transmit motion data to the wearable device 401. In an embodiment, the wearable device 401 may set the pairing area based on a time required for the wearable devices (e.g., 805, 811, 821, 822, 823, 824, and 825) to pair with the wearable device 401 and a time required to transmit motion data to the wearable device 401.

In an embodiment, in a case where a plurality of motion sensors are included in one wearable device, the wearable device 401 may transmit the signal (e.g., the wake-up signal and/or the connection request signal) so that the one wearable device transmits, to the wearable device 401, motion data obtained through some motion sensors among the plurality of motion sensors. For example, the wearable device 401 may transmit the signal (e.g., the wake-up signal and/or the connection request signal) to a wearable device (e.g., 811) to transmit, to the wearable device 401, motion data obtained through a selected motion sensor among a plurality of motion sensors of the wearable device (e.g., 811) attached to each of the fingers of the user 500. However, the present disclosure is not limited to the above example embodiment. The wearable device 401 may transmit the signal (e.g., the wake-up signal and/or the connection request signal) to the wearable device (e.g., 811) to transmit, to the wearable device 401, motion data obtained through all of the plurality of motion sensors of the wearable device (e.g., 811) attached to each of the fingers of the user 500.

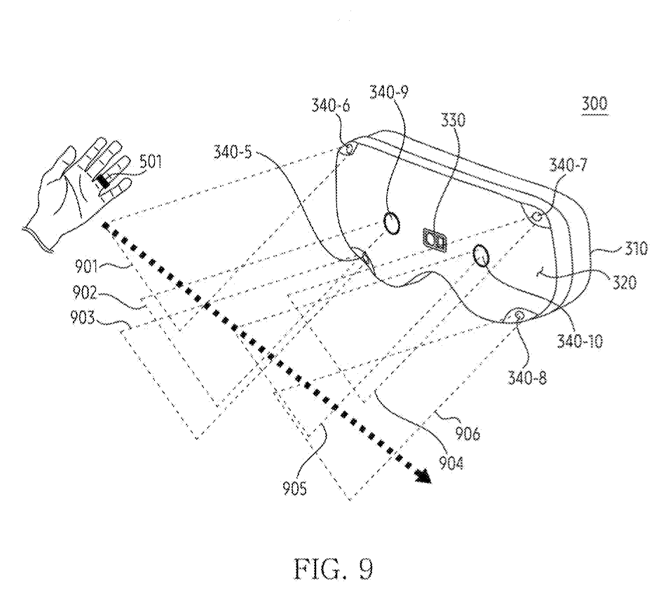

FIG. 9 illustrates an example of a field of view (FOV) of a wearable device according to a movement of a hand of a user in an embodiment.

A wearable device 300 of FIG. 9 may correspond to the electronic device 101 of FIG. 1. The wearable device 300 of FIG. 9 may correspond to the wearable device 200 of FIGS. 2A and 2B. The wearable device 300 of FIG. 9 may correspond to the wearable device 300 of FIGS. 3A and 3B. The wearable device 300 of FIG. 9 may correspond to the wearable device 401 of FIG. 4. A wearable device 501 of FIG. 9 may correspond to the wearable device 501 of FIGS. 5A, 5B, and 5C. FIG. 9 may be described with reference to FIGS. 1, 2A, 2B, 3A, 3B, 4, 5A, 5B, 5C, 5D, 6A, 6B, and 6C.

Referring to FIG. 9, the wearable device 300 may include one or more cameras 340-5, 340-6, 340-7, 340-8, 340-9, and 340-10. The wearable device 300 may obtain, through the one or more cameras 340-5, 340-6, 340-7, 340-7, 340-8, 340-9, and 340-10, an image with respect to a field of view 901, 902, 903, 903, 904, 905, or 906 of each of the one or more cameras 340-5, 340-6, 340-7, 340-7, 340-8, 340-9, and 340-10.

In an embodiment, the wearable device 300 may identify a movement of a hand of a user within the fields of view 901, 902, 903, 904, 905, and 906 of the one or more cameras 340-5, 340-6, 340-7, 340-8, 340-9, and 340-10.

In an embodiment, when the hand moves out of any one field of view among the fields of view 901, 902, 903, 904, 905, and 906 as the hand of the user moves, the wearable device 300 may turn off a camera for obtaining the field of view from which the hand has moved out. In an embodiment, when the hand enters any one field of view among the fields of view 901, 902, 903, 904, 905, and 906 as the hand of the user moves, the wearable device 300 may turn on a camera for obtaining the field of view from which the hand has entered.

In an embodiment, the wearable device 300 may identify a first distance and/or a second distance based on the fields of view 901, 902, 903, 904, 905, and 906. For example, in a case where an outer angle of a field of view is included in another field of view, the wearable device 300 may not set the first distance and/or the second distance with respect to the outer angle of the field of view included in the other field of view. For example, in a case where the outer angle of the field of view is not included in any field of view, the wearable device 300 may set the first distance and/or the second distance with respect to the outer angle of the field of view that is not included in any field of view.

In an embodiment, the wearable device 300 may set the first distance and/or the second distance through a field of view based on some selected cameras among the one or more cameras 340-5, 340-6, 340-7, 340-8, 340-9, and 340-10. In an embodiment, as the wearable device 300 sets the first distance and/or the second distance through the field of view based on some selected cameras among the one or more cameras 340-5, 340-6, 340-7, 340-8, 340-9, and 340-10, the first distance and/or the second distance may be changed according to the fields of view 901, 902, 903, 904, 905, and 906 of the selected cameras. For example, in a case where the wearable device 501 is moved from the field of view 902 of the camera 340-9 to the field of view 905 of the camera 340-10 in a state in which the cameras 340-7 and 340-8 are turned off (i.e., a state in which the fields of view 904 and 906 are not obtained), the wearable device 300 may set the first distance and/or the second distance in the field of view 905 of the camera 340-10. For example, in a case where the wearable device 501 is moved from the field of view 902 of the camera 340-9 to the field of view 905 of the camera 340-10 in a state in which the cameras 340-7 and 340-8 are turned on (i.e., a state in which the fields of view 904 and 906 are obtained), the wearable device 300 may set the first distance and/or the second distance in the fields of view 904 and 906 other than the field of view 905 of the camera 340-10.

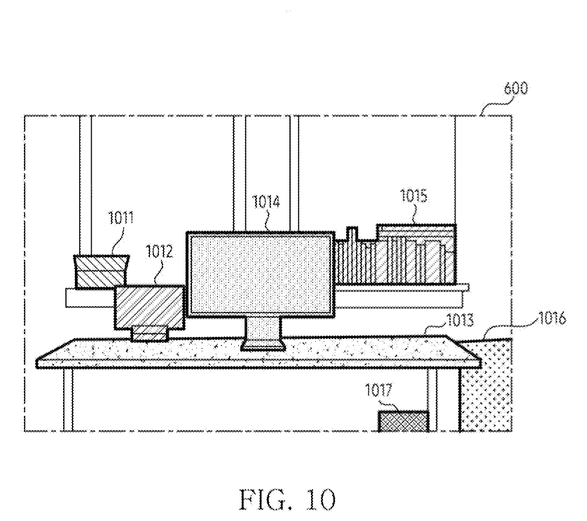

FIG. 10 illustrates an example of a situation of a front surface of a wearable device in an embodiment.

In an embodiment, a wearable device 401 may identify one or more objects 1011, 1012, 1013, 1014, 1015, 1016, and 1017 within a FOV 600 of a camera 425. In an embodiment, the wearable device 401 may identify the one or more objects 1011, 1012, 1013, 1014, 1015, 1016, and 1017 within the FOV 600 of the camera 425 based on object recognition and/or scene understanding. In an embodiment, the object 1011 is an organizer box, the object 1012 is a board, the object 1013 is a desk, the object 1014 is a monitor, the object 1015 is books, object 1016 is an auxiliary drawer, and the object 1017 may be a trash can.

In an embodiment, the wearable device 401 may set a probability of obstruction based on a result of object recognition and/or scene understanding. In an embodiment, the probability of obstruction may be determined based on an artificial intelligence model trained to calculate a probability of obstruction based on a type of object. In an embodiment, the artificial intelligence model may be reinforcement-learned to calculate the probability of obstruction updated according to whether it is actually occluded by a movement of a hand 611 of a user 500 of the wearable device 401. However, the present disclosure is not limited to the above example embodiment. In an embodiment, the probability of obstruction may be determined based on the artificial intelligence model trained to calculate the probability of obstruction based on a distance between an object and the hand 611 and/or a disposition of the object within the FOV 600. For example, the wearable device 401 may identify, through the artificial intelligence model, that a probability of obstruction of the object 1011 is 3.5%, a probability of obstruction of the object 1012 is 5%, a probability of obstruction of the object 1013 is 75%, a probability of obstruction of the object 1014 is 25%, a probability of obstruction of the object 1015 is 2.5%, a probability of obstruction of the object 1016 is 12%, and a probability of obstruction of the object 1017 is 15%.

In an embodiment, the wearable device 401 may set a first distance and a second distance with respect to each of the one or more objects 1011, 1012, 1013, 1014, 1015, 1016, and 1017 according to the probability of obstruction of each of the one or more objects 1011, 1012, 1013, 1014, 1015, 1016, and 1017. In an embodiment, the wearable device 401 may set the first distance and the second distance with respect to each of the one or more objects 1011, 1012, 1013, 1014, 1015, 1016, and 1017 as a value obtained by multiplying the first distance and the second distance by the probability of obstruction of each of the one or more objects 1011, 1012, 1013, 1014, 1015, 1016, and 1017. However, the present disclosure is not limited to the above example embodiment.

In an embodiment, the wearable device 401 may set a probability of inputting a gesture when the hand of the user 500 is occluded by an object based on the result of object recognition and/or scene understanding.

In an embodiment, the probability of inputting a gesture may be determined based on an artificial intelligence model trained to calculate a probability of inputting a gesture based on a type of object. In an embodiment, the artificial intelligence model may be reinforcement-learned to calculate a probability of inputting a gesture updated according to the number of times the gesture is input, in a case where it is actually occluded by a movement of the hand 611 of the user 500 of the wearable device 401. For example, the wearable device 401 may train the artificial intelligence model to reduce the probability of inputting the updated gesture, in a case where the user 500 does not input a gesture while the hand 611 of the user 500 is occluded by the object 1017, which is the trash can. However, the present disclosure is not limited to the above example embodiment.

In an embodiment, the wearable device 401 may determine whether to set the first distance and the second distance with respect to each of the one or more objects 1011, 1012, 1013, 1014, 1015, 1016, and 1017 according to a probability of inputting a gesture of each of the one or more objects 1011, 1012, 1013, 1014, 1015, 1016, and 1017. In an embodiment, the wearable device 401 may not set the first distance and the second distance with respect to an object having a probability of inputting a gesture less than or equal to a reference probability among the one or more objects 1011, 1012, 1013, 1014, 1015, 1016, and 1017. In an embodiment, the wearable device 401 may set the first distance and the second distance with respect to an object having a probability of inputting a gesture greater than a reference probability among the one or more objects 1011, 1012, 1013, 1014, 1015, 1016, and 1017. However, the present disclosure is not limited to the above example embodiment.

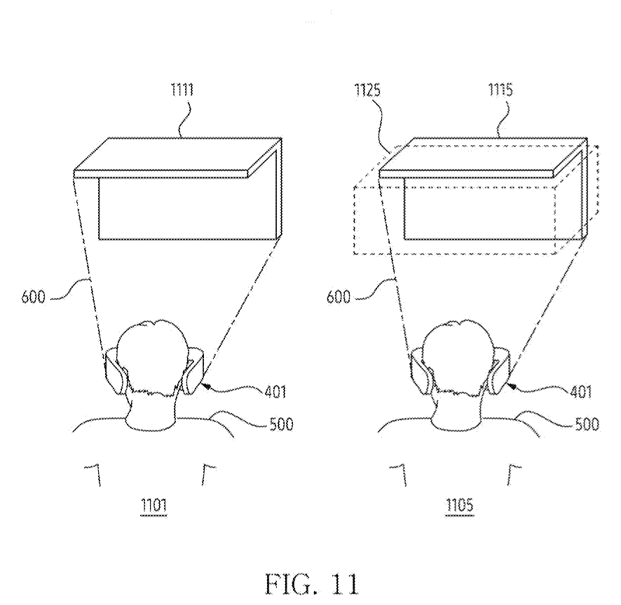

FIG. 11 illustrates an example of a situation 1101 or 1105 in which a wearable device sets an obstruction area with respect to an obstruction object in an embodiment.

Referring to FIG. 11, a wearable device 401 may obtain, through a camera 425, an image with respect to a FOV 600 of the camera 425. In an embodiment, the wearable device 401 may perform object recognition and/or scene understanding based on the image obtained through the camera 425. In an embodiment, the wearable device 401 may identify an object (e.g., a desk) within the FOV 600 of the camera 425 based on object recognition and/or scene understanding.

In an embodiment, the wearable device 401 may identify one or more obstruction areas 1111 and 1115. In an embodiment, the obstruction areas 1111 and 1115 may be areas in which a hand 611 (or a finger) is not identified through the FOV 600 of the camera 425. For example, the obstruction area 1111 may be an area of an obstruction object (e.g., a desk), among objects within the FOV 600, that may occlude the hand 611 (or the finger) according to a movement of the hand 611 (or the finger). Herein, the obstruction object (e.g., the desk) occluding the hand 611 (or the finger) may mean that the obstruction object (e.g., the desk) is located between the hand 611 (or the finger) and the camera 425.

In an embodiment, the wearable device 401 may further identify an additional obstruction area 1125. In an embodiment, the wearable device 401 may further identify the additional obstruction area 1125 based on object recognition and/or scene understanding. In an embodiment, in a case where a wearable device 501 is worn on the hand 611, the wearable device 401 may further identify the additional obstruction area 1125 based on object recognition and/or scene understanding. In an embodiment, when identifying that the wearable device 501 is worn on the hand 611, the wearable device 401 may further identify the additional obstruction area 1125 based on object recognition and/or scene understanding. In an embodiment, the additional obstruction area 1125 may be an area in which the hand 611 (or the finger) may be occluded by an obstruction object (e.g., a desk). In an embodiment, the additional obstruction area 1125 may be set to an area within a designated distance from a boundary of an edge of the obstruction object (e.g., the desk).

In an embodiment, the wearable device 401 may identify (or set) first distances 731 and 735 and second distances 751 and 755 from the additional obstruction area 1125 based on a movement of the hand 611. In an embodiment, in a case where the wearable device 501 is worn on the hand 611, the wearable device 401 may identify (or set) the first distances 731 and 735 and the second distances 751 and 755 from the additional obstruction area 1125 based on the movement of the hand 611.

FIG. 12 is a flowchart representing an operation of a wearable device according to an embodiment.

FIG. 12 may be described with reference to FIGS. 1, 2A, 2B, 3A, 3B, 4, 5A, 5B, 5C, 5D, 6A, and 6B.

Referring to FIG. 12, in operation 1210, a wearable device 401 may identify a movement of a hand 611. In an embodiment, the wearable device 401 may identify a movement of the hand 611 within a FOV 600 of a camera 425. In an embodiment, the wearable device 401 may identify a relative movement of the hand 611. Herein, the relative movement may include a direct movement of the hand 611, a movement of the hand 611 relative to the FOV 600 according to a movement of the wearable device 401, and/or a movement of the hand 611 relative to an object according to a movement of the object within the FOV 600. Hereinafter, the movement of the hand 611 and the relative movement of the hand 611 may be referred to as a movement of the hand 611. In an embodiment, the movement of the hand 611 may be identified based on a movement direction and/or movement speed of the hand 611. In an embodiment, the relative movement of the hand 611 may be identified based on a relative movement direction and/or relative movement speed with respect to an arbitrary target (e.g., the FOV 600 and/or an object) of the hand 611.

In operation 1220, the wearable device 401 may set a first distance corresponding to the movement. In an embodiment, the wearable device 401 may identify the first distance from obstruction areas 620 and 625 based on the movement of the hand 611. In an embodiment, the wearable device 401 may identify the first distance reachable by the hand 611 within a designated first time in the obstruction areas 620 and 625 according to the movement of the hand 611. In an embodiment, the wearable device 401 may set the first distance from each of the obstruction areas 620 and 625 based on positions reachable within a designated time in the obstruction areas 620 and 625, based on a movement direction and/or movement speed of the hand 611. In an embodiment, the first time may be determined based on a processing delay time. In an embodiment, the first time may be determined based on a time required for a wearable device 501 to transmit motion data to the wearable device 401. For example, the first time may include a delay time by a network between the wearable device 401 and the wearable device 501. For example, the first time may include a delay time for processing motion data of the wearable device 401 and/or the wearable device 501. For example, the first time may include the delay time by the network and the delay time for processing the motion data.

In operation 1230, the wearable device 401 may determine whether the hand 611 is within the first distance from an obstruction area. In an embodiment, the wearable device 401 may identify whether the hand 611 is within the first distance from one obstruction area among the one or more obstruction areas 620 and 625.

In operation 1230, the wearable device 401 may perform operation 1240 in response to identifying that the hand 611 is within the first distance from the obstruction area. In operation 1230, the wearable device 401 may perform operation 1260 in response to identifying that the hand 611 exceeds the first distance from the obstruction area.

In operation 1240, the wearable device 401 may request motion data from the other wearable device 501. In an embodiment, the wearable device 401 may transmit a wake-up signal to the wearable device 501 worn on the hand 611 in response to identifying that the hand 611 is within the first distance from the obstruction area. In an embodiment, the wearable device 501 may transition from a low-power state 593 to a normal state 591 in response to receiving the wake-up signal. In an embodiment, the wearable device 401 may request the motion data from the wearable device 501 while the wearable device 501 operates in the normal state 591. In an embodiment, the wearable device 401 may request the motion data from the wearable device 501 while the hand 611 is located within the first distance from the obstruction area.

In operation 1250, the wearable device 401 may identify a gesture based on a motion and/or the motion data.

In an embodiment, the wearable device 401 may identify a first gesture based on one or more consecutive movements of the hand 611 identified through the camera 425. In an embodiment, the wearable device 401 may identify the first gesture based on the one or more consecutive movements of the hand 611 while the wearable device 501 operates in the normal state 591.

In an embodiment, the wearable device 401 may identify a second gesture (or a pose) of the wearable device 501 based on the motion data from the wearable device 501. In an embodiment, the wearable device 401 may identify motions of the wearable device 501 based on the motion data. In an embodiment, the wearable device 401 may identify the second gesture (or the pose) of the wearable device 501 based on the motions of the wearable device 501. In an embodiment, the wearable device 401 may identify the second gesture based on the motion data obtained while the wearable device 501 operates in the normal state 591.

After operation 1250, the wearable device 401 may perform a function set with respect to a user input based on the first gesture and/or the second gesture. In an embodiment, the wearable device 401 may perform the function set with respect to the user input based on the first gesture and/or the second gesture obtained while the wearable device 501 operates in the normal state 591.

In operation 1260, wearable device 401 may identify the gesture based on the movement. In an embodiment, the wearable device 401 may identify the first gesture based on the one or more consecutive movements of the hand 611 identified through the camera 425. In an embodiment, the wearable device 401 may identify the first gesture based on the one or more consecutive movements of the hand 611 while the wearable device 501 operates in the normal state 591.

After operation 1260, the wearable device 401 may perform a function set with respect to a user input based on the first gesture.

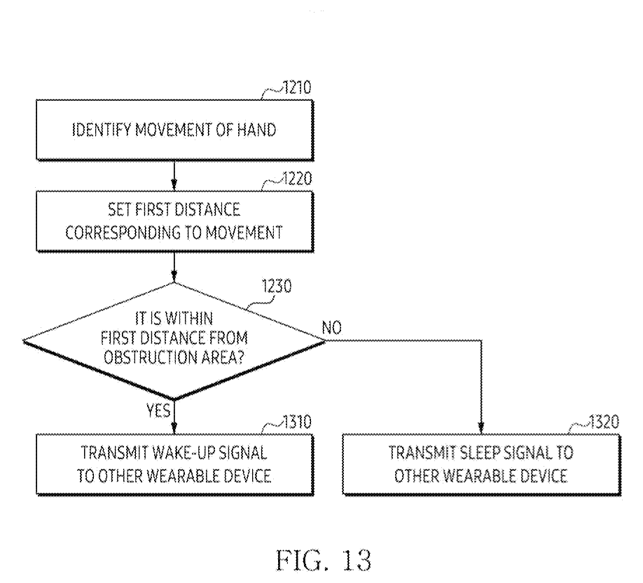

FIG. 13 is a flowchart representing an operation of a wearable device according to an embodiment.

FIG. 13 may be described with reference to FIGS. 1, 2A, 2B, 3A, 3B, 4, 5A, 5B, 5C, 5D, 6A, 6B, and 12.

Operations 1210, 1220, or 1230 of FIG. 13 may correspond to operations 1210, 1220, or 1230 of FIG. 12, respectively.

Referring to FIG. 13, in operation 1210, a wearable device 401 may identify a movement of a hand 611. In an embodiment, the wearable device 401 may identify a movement of the hand 611 within a FOV 600 of a camera 425.

In operation 1220, the wearable device 401 may set a first distance corresponding to the movement. In an embodiment, the wearable device 401 may identify the first distance from obstruction areas 620 and 625 based on the movement of the hand 611.

In operation 1230, the wearable device 401 may determine whether the hand 611 is within the first distance from an obstruction area. In an embodiment, the wearable device 401 may identify whether the hand 611 is within the first distance from one obstruction area among the one or more obstruction areas 620 and 625.

In operation 1230, the wearable device 401 may perform operation 1310 in response to identifying that the hand 611 is within the first distance from the obstruction area. In operation 1230, the wearable device 401 may perform operation 1320 in response to identifying that the hand 611 exceeds the first distance from the obstruction area.

In operation 1310, the wearable device 401 may transmit a wake-up signal to another wearable device 501. In an embodiment, the wearable device 401 may transmit the wake-up signal to the wearable device 501 worn on the hand 611, in response to identifying that the hand 611 is within the first distance from the obstruction area. In an embodiment, the wearable device 501 may receive the wake-up signal through communication circuitry 590. In an embodiment, the wearable device 501 may transition from a low-power state 593 to a normal state 591 in response to receiving the wake-up signal. In an embodiment, the communication circuitry 590 of the wearable device 501 may transition from a sleep state to an active state in response to receiving the wake-up signal. In an embodiment, as the wearable device 501 transitions from the low-power state 593 to the normal state 591, a processor 520, a motion sensor 573, and the communication circuitry 590 of the wearable device 501 may transition to the active state.

In operation 1320, the wearable device 401 may transmit a sleep signal to the other wearable device 501. In an embodiment, the wearable device 401 may transmit the sleep signal to the wearable device 501 worn on the hand 611, in response to identifying that the hand 611 moves out of the first distance from the obstruction area. In an embodiment, the wearable device 501 may receive the sleep signal through the communication circuitry 590. In an embodiment, the wearable device 501 may transition from the normal state 591 to the low-power state 593 in response to receiving the sleep signal. In an embodiment, the communication circuitry 590 of the wearable device 501 may transition from the active state to the sleep state in response to receiving the sleep signal. In an embodiment, as the wearable device 501 transitions from the normal state 591 to the low-power state 593, at least a part of the processor 520, the motion sensor 573, or the communication circuitry 590 of the wearable device 501 may transition to an inactive state.

In an embodiment, operation 1310 of FIG. 13 may be performed before operation 1240 of FIG. 12. In an embodiment, operation 1320 of FIG. 13 may be performed before operation 1260 of FIG. 12. However, the present disclosure is not limited to the above example embodiment.

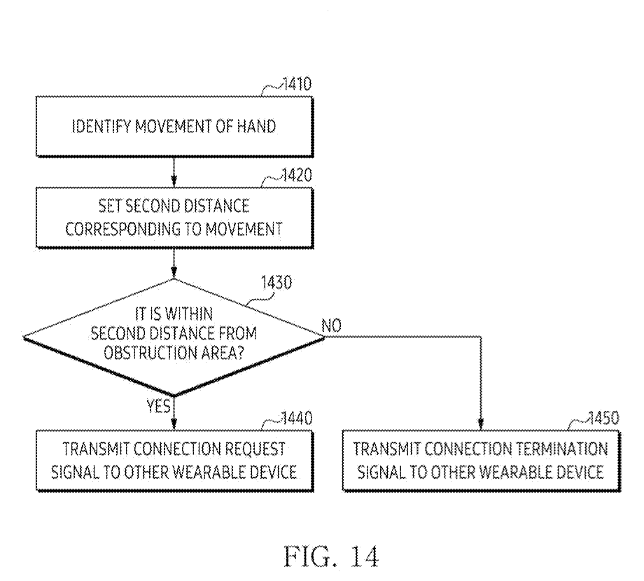

FIG. 14 is a flowchart representing an operation of a wearable device according to an embodiment.

FIG. 14 may be described with reference to FIGS. 1, 2A, 2B, 3A, 3B, 4, 5A, 5B, 5C, 5D, 6A, 6B, and 12.

Referring to FIG. 14, in operation 1410, a wearable device 401 may identify a movement of a hand 611. In an embodiment, the wearable device 401 may identify a movement of the hand 611 within a FOV 600 of a camera 425.

In operation 1420, wearable device 401 may set a second distance corresponding to the movement. In an embodiment, the wearable device 401 may identify the second distance from obstruction areas 620 and 625 based on the movement of the hand 611.

In operation 1430, the wearable device 401 may determine whether the hand 611 is within the second distance from an obstruction area. In an embodiment, the wearable device 401 may identify whether the hand 611 is within the second distance from one obstruction area among the one or more obstruction areas 620 and 625.

In operation 1430, the wearable device 401 may perform operation 1440 in response to identifying that the hand 611 is within the second distance from the obstruction area. In operation 1430, the wearable device 401 may perform operation 1450 in response to identifying that the hand 611 exceeds the second distance from the obstruction area.

In operation 1440, the wearable device 401 may transmit a connection request signal to another wearable device 501. In an embodiment, the wearable device 401 may transmit the connection request signal to the wearable device 501 worn on the hand 611, in response to identifying that the hand 611 is within the second distance from the obstruction area. In an embodiment, the wearable device 501 may receive the connection request signal through communication circuitry 590. In an embodiment, the wearable device 501 may transition from an ultra-low-power state 595 to a low-power state 593 in response to receiving the connection request signal. In an embodiment, the communication circuitry 590 of the wearable device 501 may transition from a standby state to a sleep state in response to receiving the connection request signal.

In operation 1450, the wearable device 401 may transmit a connection termination signal to the other wearable device 501. In an embodiment, the wearable device 401 may transmit the connection termination signal to the wearable device 501 worn on the hand 611, in response to identifying that the hand 611 moves out of the second distance from the obstruction area. In an embodiment, the wearable device 501 may receive the connection termination signal through the communication circuitry 590. In an embodiment, the wearable device 501 may transition from the low-power state 593 to the ultra-low-power state 595 in response to receiving the connection termination signal. In an embodiment, the communication circuitry 590 of the wearable device 501 may transition from the sleep state to the standby state in response to receiving the connection termination signal in the low-power state 593.

As described above, a wearable device 101, 200, 300, or 401 may comprise communication circuitry 435. The wearable device 101, 200, 300, or 401 may comprise a camera 180, 240-2, 240-3, 340-5, 340-6, 340-7, 340-8, 340-9, 340-10, or 425 arranged to capture an image of a part of a body of a user 500 wearing the wearable device 101, 200, 300, or 401. The wearable device 101, 200, 300, or 401 may comprise a processor 120 or 410. The wearable device 101, 200, 300, or 401 may comprise memory 130 or 415 storing instructions. The instructions, when executed by the processor 120 or 410, may cause the wearable device 101, 200, 300 or 401 to identify a relative movement of a hand 611 of the user 500 wearing another wearable device 501 in a field of view (FOV) 600 of the camera 180, 240-2, 240-3, 340-5, 340-6, 340-7, 340-8, 340-9, 340-10, or 425. The other wearable device 501 may be in a low-power state 593 in which obtaining motion data of the other wearable device 501, through a sensor 573 of the other wearable device 501, has been ceased (or is ceased). The instructions, when executed by the processor 120 or 410, may cause the wearable device 101, 200, 300 or 401 to set a first area 630 or 635 within a first distance corresponding to the relative movement from an obstruction area 620 or 625 in which the hand 611 is not identified through the FOV 600 of the camera 180, 240-2, 240-3, 340-5, 340-6, 340-7, 340-8, 340-9, 340-10, or 425. The instructions, when executed by the processor 120 or 410, may cause the wearable device 101, 200, 300 or 401 to, in response to identifying that the hand 611 moves into the first area 630 or 635, request, through the communication circuitry 435, the motion data from the other wearable device 501. The instructions, when executed by the processor 120 or 410, may cause the wearable device 101, 200, 300 or 401 to obtain, through the communication circuitry 435, motion data from the other wearable device 501 transitioning from the low-power state 593 to a normal state 591 based on the hand 611 moving into the first area 630 or 635. The instructions, when executed by the processor 120 or 410, may cause the wearable device 101, 200, 300 or 401 to identify, based on the motion data, a gesture of the user 500 through the hand 611.

The instructions, when executed by the processor 120 or 410, may cause the wearable device 101, 200, 300 or 401 to, in response to identifying that the hand 611 moves out of the first area 630 or 635, transmit, through the communication circuitry 435, a signal instructing a transition to the low-power state 593 to the other wearable device 501.

The first distance may be a distance reachable by the hand 611 within a designated first time in the obstruction area 620 or 625 according to the relative movement.

The obstruction area 620 or 625 may be an area outside the FOV 600.

The obstruction area 620 or 625 may be an area of an obstruction object capable of occluding the hand 611 according to the relative movement of the hand 611 among objects within the FOV 600.

The obstruction area 620 or 625 may be an area of an object where a probability that the user 500 performs the gesture when the hand 611 is occluded by the obstruction object, among the obstruction objects capable of occluding the hand 611, is equal to or greater than a reference probability.

The instructions, when executed by the processor 120 or 410, may cause the wearable device 101, 200, 300 or 401 to set a second area 640 or 645 longer than the first distance and within a second distance corresponding to the relative movement from the obstruction area 620 or 625. The instructions, when executed by the processor 120 or 410, may cause the wearable device 101, 200, 300 or 401 to, in response to identifying that the hand 611 moves into the second area 640 or 645, transmit, through the communication circuitry 435, a signal requesting a communication connection with other communication circuitry 435 of the other wearable device 501 to the other wearable device 501.

The instructions, when executed by the processor 120 or 410, may cause the wearable device 101, 200, 300 or 401 to, in response to identifying that the hand 611 moves out of the second area 640 or 645, transmit another signal for causing the other communication circuitry 435 of the other wearable device 501 to sleep to the other wearable device 501 through the communication circuitry 435.

The instructions, when executed by the processor 120 or 410, may cause the wearable device 101, 200, 300 or 401 to identify a SOC of a battery of the other wearable device 501 through the communication circuitry 435. The instructions, when executed by the processor 120 or 410, may cause the wearable device 101, 200, 300 or 401 to, in a case where the SOC is equal to or less than a designated SOC, set the second area 640 or 645.

The instructions, when executed by the processor 120 or 410, may cause the wearable device 101, 200, 300 or 401 to, while the hand 611 is located outside the first area 630 or 635, identify the gesture of the user 500 based on the relative movement of the hand 611 without the motion data.

The instructions, when executed by the processor 120 or 410, may cause the wearable device 101, 200, 300 or 401 to, in response to identifying that the hand 611 moves into the first area 630 or 635, in a case where the first wearable device 101, 200, 300, or 401 is worn on a second position of the hand 611 different from a first position of the hand 611 where the other wearable device 501 is worn, request other motion data of the other wearable device 501 from the other wearable device 501 through the communication circuitry 435. The instructions, when executed by the processor 120 or 410, may cause the wearable device 101, 200, 300 or 401 to, in a case where the other wearable device 501 is not worn, request the motion data from the other wearable device 501 through the communication circuitry 435.

The instructions, when executed by the processor 120 or 410, may cause the wearable device 101, 200, 300 or 401 to identify a SOC of a battery of the other wearable device 501 through the communication circuitry 435. The instructions, when executed by the processor 120 or 410, may cause the wearable device 101, 200, 300 or 401 to, in a case where the SOC is equal to or less than a designated SOC, transmit a signal instructing a transition to the low-power state 593 to the other wearable device 501 through the communication circuitry 435.

As described above, a method may be performed by a wearable device 101, 200, 300, or 401 including communication circuitry 435 and a camera 180, 240-2, 240-3, 340-5, 340-6, 340-7, 340-8, 340-9, 340-10, or 425 arranged to capture an image of a part of a body of a user 500 wearing the wearable device 101, 200, 300, or 401. The method may comprise identifying a relative movement of a hand 611 of the user 500 wearing another wearable device 501 in a field of view (FOV) 600 of the camera 180, 240-2, 240-3, 340-5, 340-6, 340-7, 340-8, 340-9, 340-10, or 425. The other wearable device 501 may be in a low-power state 593 in which obtaining motion data of the other wearable device 501, through a sensor 573 of the other wearable device 501, has been ceased. The method may comprise setting a first area 630 or 635 within a first distance corresponding to the relative movement from an obstruction area 620 or 625 in which the hand 611 is not identified through the FOV 600 of the camera 180, 240-2, 240-3, 340-5, 340-6, 340-7, 340-8, 340-9, 340-10, or 425. The method may comprise, in response to identifying that the hand 611 moves into the first area 630 or 635, requesting, through the communication circuitry 435, the motion data from the other wearable device 501. The method may comprise obtaining, through the communication circuitry 435, motion data from the other wearable device 501 transitioning from the low-power state 593 to a normal state 591 based on the hand 611 moving into the first area 630 or 635. The method may comprise identifying, based on the motion data, a gesture of the user 500 through the hand 611.

The method may comprise, in response to identifying that the hand 611 moves out of the first area 630 or 635, transmitting, through the communication circuitry 435, a signal instructing a transition to the low-power state 593 to the other wearable device 501.

The first distance may be a distance reachable by the hand 611 within a designated first time in the obstruction area 620 or 625 according to the relative movement.

The method may comprise setting a second area 640 or 645 longer than the first distance and within a second distance corresponding to the relative movement from the obstruction area 620 or 625. The method may comprise, in response to identifying that the hand 611 moves into the second area 640 or 645, transmitting, through the communication circuitry 435, a signal requesting a communication connection with other communication circuitry 435 of the other wearable device 501 to the other wearable device 501.

The method may comprise, in response to identifying that the hand 611 moves out of the second area 640 or 645, transmitting another signal for causing the other communication circuitry 435 of the other wearable device 501 to sleep to the other wearable device 501 through the communication circuitry 435.

The method may comprise identifying a SOC of a battery of the other wearable device 501 through the communication circuitry 435. The method may comprise, in a case where the SOC is equal to or less than a designated SOC, setting the second area 640 or 645.

As described above, a non-transitory computer-readable storage medium may store a program including instructions. The instructions, when executed by a processor 120 or 410 of a wearable device 101, 200, 300, or 401 including communication circuitry 435 and a camera 180, 240-2, 240-3, 340-5, 340-6, 340-7, 340-8, 340-9, 340-10, or 425 arranged to capture an image of a part of a body of a user 500 wearing the wearable device 101, 200, 300, or 401, may cause the wearable device 101, 200, 300, or 401 to identify a relative movement of a hand 611 of the user 500 wearing another wearable device 501 in a field of view (FOV) 600 of the camera 180, 240-2, 240-3, 340-5, 340-6, 340-7, 340-8, 340-9, 340-10, or 425. The other wearable device 501 may be in a low-power state 593 in which obtaining motion data of the other wearable device 501, through a sensor 573 of the other wearable device 501, has been ceased. The instructions, when executed by the processor 120 or 410, may cause the wearable device 101, 200, 300 or 401 to set a first area 630 or 635 within a first distance corresponding to the relative movement from an obstruction area 620 or 625 in which the hand 611 is not identified through the FOV 600 of the camera 180, 240-2, 240-3, 340-5, 340-6, 340-7, 340-8, 340-9, 340-10, or 425. The instructions, when executed by the processor 120 or 410, may cause the wearable device 101, 200, 300 or 401 to, in response to identifying that the hand 611 moves into the first area 630 or 635, request, through the communication circuitry 435, the motion data from the other wearable device 501. The instructions, when executed by the processor 120 or 410, may cause the wearable device 101, 200, 300 or 401 to obtain, through the communication circuitry 435, motion data from the other wearable device 501 transitioning from the low-power state 593 to a normal state 591 based on the hand 611 moving into the first area 630 or 635. The instructions, when executed by the processor 120 or 410, may cause the wearable device 101, 200, 300 or 401 to identify, based on the motion data, a gesture of the user 500 through the hand 611.

The instructions, when executed by the processor 120 or 410, may cause the wearable device 101, 200, 300 or 401 to, in response to identifying that the hand 611 moves out of the first area 630 or 635, transmit, through the communication circuitry 435, a signal instructing a transition to the low-power state 593 to the other wearable device 501.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

Various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., through at least one wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable device comprising:
communication circuitry;
a camera configured to capture an image of a part of a body of a user wearing the wearable device;
at least one processor comprising processing circuitry; and
memory comprising one or more storage mediums storing instructions,
wherein the instructions, when executed by the at least one processor individually or collectively, cause the wearable device to:
identify a relative movement of a hand of the user wearing another wearable device in a field-of-view (FOV) of the camera, wherein the other wearable device is in a low-power state in which obtaining motion data of the other wearable device, through a sensor of the other wearable device, is ceased;
set a first area within a first distance corresponding to the relative movement from an obstruction area in which the hand is not identified through the FOV of the camera;
based on identifying that the hand moves into the first area, request, through the communication circuitry, the motion data from the other wearable device;
obtain, through the communication circuitry, motion data from the other wearable device transitioning from the low-power state to a normal state based on the hand moving into the first area; and
identify, based on the motion data, a gesture of the user through the hand.

2. The wearable device of claim 1, wherein the instructions, when executed by the at least one processor individually or collectively, further cause the wearable device to, based on identifying that the hand moves out of the first area, transmit, through the communication circuitry, a signal instructing a transition to the low-power state to the other wearable device.

3. The wearable device of claim 1, wherein the first distance is a distance reachable by the hand within a designated first time in the obstruction area based on the relative movement.

4. The wearable device of claim 1, wherein the obstruction area is outside the FOV.

5. The wearable device of claim 1, wherein the obstruction area includes an obstruction object capable of occluding the hand based on the relative movement of the hand among objects within the FOV.

6. The wearable device of claim 5, wherein the obstruction area includes an object where a probability that the user performs the gesture in a case that the hand is occluded by the obstruction object, among the obstruction objects capable of occluding the hand, is equal to or greater than a reference probability.

7. The wearable device of claim 1, wherein the instructions, when executed by the at least one processor individually or collectively, further cause the wearable device to:
set a second area longer than the first distance and within a second distance corresponding to the relative movement from the obstruction area; and
based on identifying that the hand moves into the second area, transmit, through the communication circuitry, a signal requesting a communication connection with other communication circuitry of the other wearable device to the other wearable device.

8. The wearable device of claim 7, wherein the instructions, when executed by the at least one processor individually or collectively, further cause the wearable device to, based on identifying that the hand moves out of the second area, transmit another signal for causing the other communication circuitry of the other wearable device to sleep to the other wearable device through the communication circuitry.

9. The wearable device of claim 8, wherein the instructions, when executed by the at least one processor individually or collectively, further cause the wearable device to:
identify a state-of-charge (SOC) of a battery of the other wearable device through the communication circuitry; and
in a case where the SOC is equal to or less than a designated state of charge, set the second area.

10. The wearable device of claim 1, wherein the instructions, when executed by the at least one processor individually or collectively, further cause the wearable device to, in a case that the hand is located outside the first area, identify the gesture of the user based on the relative movement of the hand without the motion data.

11. The wearable device of claim 1, wherein the instructions, when executed by the at least one processor individually or collectively, further cause the wearable device to, based on identifying that the hand moves into the first area:
in a first case where the wearable device is worn on a second position of the hand different from a first position of the hand where the other wearable device is worn, request other motion data of the other wearable device from the other wearable device through the communication circuitry; and
in a second case where the other wearable device is not worn, request the motion data from the other wearable device through the communication circuitry.

12. The wearable device of claim 1, wherein the instructions, when executed by the at least one processor individually or collectively, further cause the wearable device to:
identify a state-of-charge (SOC) of a battery of the other wearable device through the communication circuitry; and
in a case where the SOC is equal to or less than a designated state of charge, transmit a signal instructing a transition to the low-power state to the other wearable device through the communication circuitry.

13. A method performed by a wearable device comprising communication circuitry and a camera configured to capture an image of a part of a body of a user wearing the wearable device, the method comprising:
identifying a relative movement of a hand of the user wearing another wearable device in a field-of-view (FOV) of the camera, wherein the other wearable device is in a low-power state in which obtaining motion data of the other wearable device, through a sensor of the other wearable device, is ceased;
setting a first area within a first distance corresponding to the relative movement from an obstruction area in which the hand is not identified through the FOV of the camera;
based on identifying that the hand moves into the first area, requesting, through the communication circuitry, the motion data from the other wearable device;
obtaining, through the communication circuitry, motion data from the other wearable device transitioning from the low-power state to a normal state based on the hand moving into the first area; and
identifying, based on the motion data, a gesture of the user through the hand.

14. The method of claim 13, further comprising, based on identifying that the hand moves out of the first area, transmitting, through the communication circuitry, a signal instructing a transition to the low-power state to the other wearable device.

15. A non-transitory computer-readable storage medium storing a program comprising instructions, wherein the instructions, when executed by at least one processor of a wearable device comprising communication circuitry and a camera configured to capture an image of a part of a body of a user wearing the wearable device, individually or collectively, cause the wearable device to:
identify a relative movement of a hand of the user wearing another wearable device in a field-of-view (FOV) of the camera, wherein the other wearable device is in a low-power state in which obtaining motion data of the other wearable device, through a sensor of the other wearable device, is ceased;
set a first area within a first distance corresponding to the relative movement from an obstruction area in which the hand is not identified through the FOV of the camera;
based on identifying that the hand moves into the first area, request, through the communication circuitry, the motion data from the other wearable device;
obtain, through the communication circuitry, motion data from the other wearable device transitioning from the low-power state to a normal state based on the hand moving into the first area; and
identify, based on the motion data, a gesture of the user through the hand.

16. The non-transitory computer-readable storage medium of claim 15, wherein the instructions, when executed by the at least one processor individually or collectively, further cause the wearable device to, based on identifying that the hand moves out of the first area, transmit, through the communication circuitry, a signal instructing a transition to the low-power state to the other wearable device.

17. The non-transitory computer-readable storage medium of claim 15, wherein the first distance is a distance reachable by the hand within a designated first time in the obstruction area based on the relative movement.

18. The non-transitory computer-readable storage medium of claim 15, wherein the obstruction area is outside the FOV.

19. The non-transitory computer-readable storage medium of claim 15, wherein the obstruction area includes an obstruction object capable of occluding the hand according to the relative movement of the hand among objects within the FOV.

20. The non-transitory computer-readable storage medium of claim 19, wherein the obstruction area includes an object where a probability that the user performs the gesture when the hand is occluded by the obstruction object, among the obstruction objects capable of occluding the hand, is equal to or greater than a reference probability.
